(19) United States
(12) Patent Application Publication
(10) Pub. No.: US 2017/0372602 A1
(43) Pub. Date: Dec. 28, 2017

(54) LADAR ENABLED TRAFFIC CONTROL

(71) Applicant: Continental Advanced Lidar Solutions US, LLC, Carpinteria, CA (US)

(72) Inventors: Patrick Gilliland, Santa Barbara, CA (US); Jan-Michael Masur, Santa Barbara, CA (US); Heiko Leppin, Santa Barbara, CA (US)

(73) Assignee: Continental Advanced Lidar Solutions US, LLC, Carpinteria, CA (US)

(21) Appl. No.: 15/629,916

(22) Filed: Jun. 22, 2017

Related U.S. Application Data
(60) Provisional application No. 62/354,313, filed on Jun. 24, 2016.

(51) Int. Cl. G08G 1/04; G08G 1/08; G01S 17/93

(52) U.S. Cl. CPC G08G 1/04; G01S 17/936; G08G 1/08

(57) ABSTRACT

A number of ladar sensors, visible cameras, and traffic signal lights are mounted within a traffic control zone, and a local traffic controller is provided to ensure safety and provide optimum traffic flow for vehicular and pedestrian traffic by combining the inputs from the ladar sensors and visible cameras and detecting the type of traffic, the intended path, and then controlling the signal lights dynamically. The local traffic controller also maintains a local traffic database, and communicates via duplex radio link with similarly equipped vehicles to effect an additional control capability. A regional traffic controller communicates with the local traffic controller to provide control and optimal traffic flow within a district control zone, and maintains a district traffic database.

### CROSS REFERENCE TO RELATED APPLICATION

This application claims the benefit of provisional patent application No. 62/354,313, filed Jun. 24, 2016, which is hereby incorporated by reference.

### TECHNICAL FIELD

The embodiments disclosed herein relate generally to 3-D image generation and the identification and tracking of objects, and more particularly to ladar sensors for traffic control at intersections and crosswalks.

BACKGROUND

The 3-D imaging technology disclosed in Stettner et al., U.S. Pat. Nos. 5,446,529, 6,133,989 and 6,414,746 provides with a single pulse of light, typically pulsed laser light, all the information of a conventional 2-D picture along with the third dimensional coordinates; it furnishes the 3-D coordinates of everything in its field of view. This use is typically referred to as flash 3-D imaging in analogy with ordinary digital 2-D cameras using flash attachments for a self-contained source of light. As with ordinary 2-D digital cameras, the light is focused by a lens on the focal plane of the ladar sensor, which contains an array of pixels called a focal plane array (FPA). In the case of a ladar sensor these pixels are “smart” and can collect data which enables a processor to calculate the round-trip time of flight of the laser pulse to reflective features on the object of interest.

Many systems have been proposed to meet the challenge of using optical imaging and video cameras in a traffic control system to control traffic, monitor safety and issue alerts. Stereo systems, holographic capture systems, and those which acquire shape from motion, have not been able to demonstrate adequate performance in this application, but 3D ladar based systems have shown the ability to rapidly capture 3-D images of objects in motion, which may be travelling on an intersecting path, with sufficient speed and accuracy to allow an intelligent traffic controller to control the available traffic signals to ensure safety, while avoiding unnecessary delays.

### SUMMARY

In one exemplary embodiment, a ladar enabled traffic control system includes at least one traffic signal configured to control traffic at an intersection. The system also includes at least one ladar sensor mounted and sighted to have a field of view at or adjacent to the intersection. A controller is in communication with the traffic signal and the at least one ladar sensor and adapted to control the condition of the traffic signal light based at least partially on data provided by the at least one ladar sensor.

In another exemplary embodiment, an integrated traffic signal and ladar sensor includes a housing, a traffic signal, and a dichroic optic. The integrated traffic signal and ladar sensor also includes a ladar sensor having a field of view. The ladar sensor includes a laser transmitter with a pulsed laser light output and a diffusing optic adapted to illuminate a reflecting surface in the field of view. The ladar sensor also includes a time zero reference circuit positioned to intercept a portion of said pulsed laser light output and having a time zero reference output adapted to signal the beginning of the pulsed laser light output. The ladar sensor further includes receiving optics adapted to collect and condition the pulsed laser light reflected from the reflecting surface. A two dimensional array of light sensitive detectors is positioned at a focal plane of the receiving optics, and each of the light sensitive detectors intercepting a pixelated portion of the pulsed laser light output reflected from the reflecting surface. Each light sensitive detector includes an output producing an electrical response signal. A detector bias circuit is connected to a voltage distribution grid of the array of light sensitive detectors. The ladar sensor further includes a readout integrated circuit with a clock circuit and a plurality of unit cell electrical circuits. Each of the unit cell electrical circuits includes an input connected to the clock circuit and to the time zero reference electrical output. Each of the unit cell electrical circuits also includes an amplifier with an input connected to one of the light sensitive detector outputs. Each amplifier includes an output. A pulse detection circuit is connected to the amplifier output. The pulse detection circuit includes a termination output. Each of the unit cell electric circuits also includes a counter connected to the time zero reference electrical output and to the clock circuit. The counter starts counting by the time zero reference electrical output. The counter is connected to, and stopped counting by the termination output. The counter includes an output proportional to the distance to the reflecting surface.

The features, functions, and advantages that have been discussed can be achieved independently in various embodiments of the present disclosure or may be combined in yet other embodiments, further details of which can be seen with reference to the following description and drawings.

### BRIEF DESCRIPTION OF THE DRAWINGS

FIG. 1 is a diagram of an installation of a four-way traffic control signal according to one exemplary embodiment, showing long range ladar and short range ladar fields of view, and communications with a central traffic control district;

FIG. 2 is a diagram showing a traffic control signal mounted vertically on a pole according to one exemplary embodiment, with the long range ladar sensor integrated into a middle signal light and the short range ladar sensor mounted to the pole below a crosswalk control signal;

FIG. 3 is a diagram showing four traffic control signals mounted on cantilevered beams supported by metal poles according to one exemplary embodiment, wherein each traffic control signal includes a long range ladar sensor having a field of view including the roadway and wherein short range ladar sensors are positioned to have a field of view including the crosswalks;

FIG. 4 is a block diagram of a typical ladar enabled traffic control zone of one exemplary embodiment which describes the functions and connections between the ladar sensors, video cameras, traffic and crosswalk signals, the local traffic controller, and connections to a local traffic database and a district traffic controller;

FIG. 5 is a functional block diagram of one exemplary embodiment which describes the functions common to both long and short range ladar sensors;

FIG. 6 shows the elements of a unit cell of a readout integrated circuit (“ROIC”) according to one exemplary embodiment;

FIG. 7A is a cross-sectional view of a black silicon detector array of one exemplary embodiment having a lateral orientation and the vertical electrical connections to a mating plane with the ROIC;

FIG. 7B is a bottom view of the detector array of FIG. 7A showing a region for a unit cell input amplifier;

FIG. 7C is a top view of the detector array of FIG. 7A showing a detection region of black silicon, a capacitive detector bias distribution grid, and resistive fusing and filtering connections;

FIG. 7D is schematic diagram of the capacitive detector bias distribution grid of FIG. 7C, and the resistive fusing and filtering connections;

FIG. 8 is a cross-sectional view of the black silicon detector array of one exemplary embodiment having a lateral orientation with an input amplifier of the unit cell implemented on the ROIC;

FIG. 9 is a cross-sectional view of the black silicon detector array of one exemplary embodiment having a vertical orientation with the pixel isolation trenches and the metallic bumps used to connect with the supporting ROIC;

FIG. 10A is a functional block diagram of the exemplary embodiment of the integrated traffic control signal and ladar sensors of FIG. 2;

FIG. 10B is a functional block diagram of the exemplary embodiment of the vehicle and integrated headlamp and ladar sensor of FIG. 1;

FIG. 11 is a cross-sectional view of the integrated traffic control signal and ladar sensor of FIGS. 2 and 10, showing the arrangement of elements common to both long and short range ladar sensors;

FIG. 12 is an isometric view showing the mating of the detector array and readout integrated circuit, common to both long and short range ladar sensors, according to an exemplary embodiment;

FIG. 13A is a top view of a ceramic substrate adapted to provide a hermetic seal for the hybrid detector array/ROIC assembly of FIG. 12 and to reduce parasitic inductances by means of a recess in the substrate, according to one exemplary embodiment;

FIG. 13B is a cross-sectional view of a ceramic substrate having a recess for mounting a readout integrated circuit;

FIG. 14 is an isometric view of the assembly of the detector array/ROIC of FIG. 12 with the ceramic substrate of FIG. 13 and the reduced profile wirebonds; and

FIG. 15 is an isometric view of the assembly of a flat window cover to the detector array/ROIC/ceramic of FIG. 14 with a flat window cover and a plastic lightguide useful in coupling a sample of the transmitted laser pulse to a section of the detector array.

### DETAILED DESCRIPTION

The exemplary embodiments described herein disclose a traffic monitoring and control system 100 having improved performance through the use of short range and/or long range ladar sensors 102, 104. The uses for such a system 100 may include, but are not limited to, managing automobile and truck traffic on roadways, pedestrian traffic, parking lot and driveway traffic, mixed pedestrian and service vehicle traffic in warehouses and airports, airplane and service vehicle traffic on runways and taxiways, ships and small craft in harbors, and any other traffic management situation. The systems 100 and devices described herein may also be useful in navigation, terrain mapping, landing and docking, and 3D movie/graphics capture. It should be noted that the term “ladar” may alternatively be referred to as “lidar,” as appreciated by those skilled in the art.

In a traffic control application, the ladar sensors 102, 104 may be incorporated into a traffic signal 106. The ladar sensor 102, 104 may be mounted adjacent to a signal light, on a vertical pole, or on a cantilevered beam extending from a vertical pole over a roadway. The ladar sensor 102, 104 of the exemplary embodiments incorporates a hybrid assembly of FPA and readout integrated circuit (“ROIC”). The ROIC is arranged as an array of unit cell electrical circuits, and each unit cell is configured to fit in an array of identical spacing and order as the mating focal plane array (FPA). The ladar sensor of the exemplary embodiments is capable of working in a single pulse mode, or in a multi-pulse mode, or in a pulsed continuous-wave mode as the situation dictates. The traffic control system incorporating the ladar sensor may have features which enable full 3D object modeling and tracking, as well as scene enhancements derived from the merging of 2D and 3D data bases and managing of both 3D ladar sensors and conventional 2D video cameras.

Each of the light sensitive detectors of the detector array has an output producing an electrical response signal from a reflected portion of the laser light output. The electrical response signals are connected to a readout integrated circuit (ROIC) with a corresponding array of unit cell electrical circuits. Each of the unit cell electrical circuits has an input connected to one of the light sensitive detector outputs, an electrical response signal amplifier and a demodulator, and a range measuring circuit connected to an output of the electrical response signal demodulator. The demodulator may be a voltage sampler and analog shift register for storing sequential samples of the electrical response signals, or it may comprise a mixer, integrator, or matched filter. In the sampling mode, each unit cell uses a reference clock to time the samples being taken in response to the captured reflection of the laser light from a target surface. The demodulation may also take place external to the readout integrated circuit, by a fast digital processor operating on a sequence of digitized samples from each pixel. The fast digital processor may employ algorithms which utilize weighted sums of sequential analog samples, or use fast Fourier transforms, convolution, integration, differentiation, curve fitting, or other digital processes on the digitized analog samples of the electrical response. The fast digital processor may also employ algorithms which isolate or segment the roadway from other objects and objects from each other. Such objects may be automobiles, bicycles, motorcycles , trucks, persons, animals, walls, signs, road obstructions etc. These algorithms may compute position and orientation, as well as object velocity. Objects, their orientation, position and velocity may be transferred to a local traffic controller for further processing and decision making. Each unit cell circuit has the ability to preserve the shape of the returned ladar pulse, and to make inferences about the shape of the surface within a pixel boundary as seen projected at a distance from the focal plane array, based on the shape of the reflected light pulse. The range measuring circuit is further connected to a reference signal providing a zero range reference for the modulated laser light output.

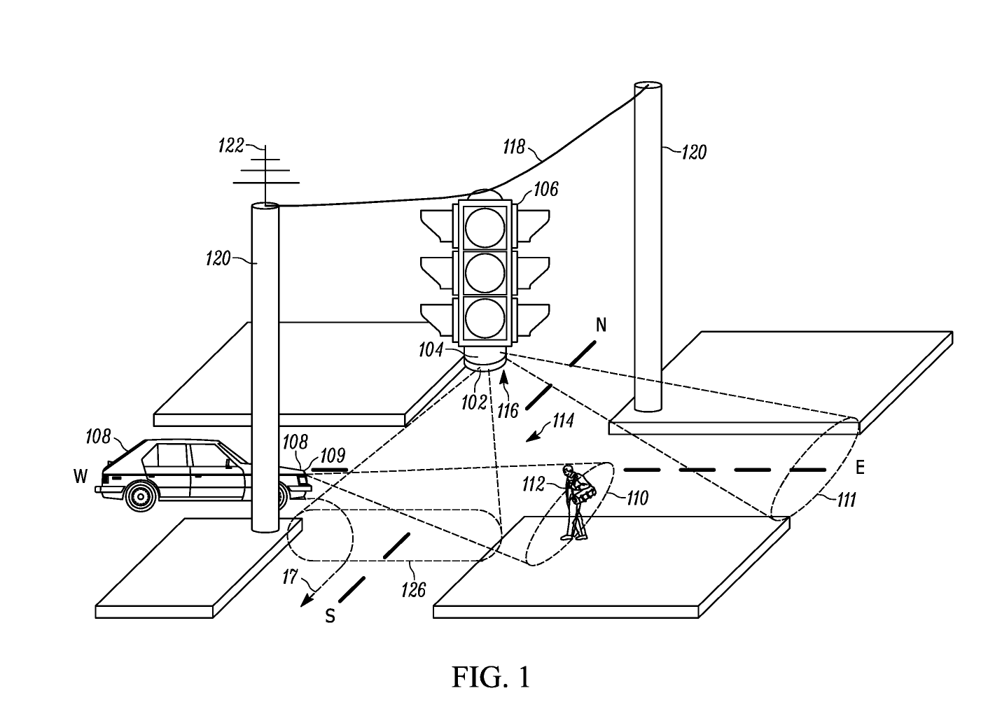

FIG. 1 depicts a situation which illustrates the advantages of an active ladar sensor technology in a basic traffic control situation. In this diagram, a vehicle 108 has a long range ladar sensor 104 mounted in a headlight assembly 109 at the front of the vehicle 108. An exemplary illumination pattern 110, i.e., a field of view, is represented by an elliptical shape shown by the dashed lines. A transmitted laser pulse diffused to cover illumination pattern 110 reflects off a pedestrian 112 utilizing a cane 113 approaching an intersection 114. The vehicle 108 may hesitate, given the possibility the pedestrian 112 with cane 113 is visually impaired or otherwise handicapped. The ladar sensor 104 embedded in the headlight 109 of vehicle 108 may give the driver of vehicle 108 a visible or audio warning, or may interact with the vehicle 108 controls for steering and braking if the pedestrian 112 is endangered.

In this exemplary embodiment, another long range ladar sensor 104, providing another illumination pattern 111 is mounted in an assembly 116 at the bottom of the traffic signal 106, suspended from a cable 118 which is supported by two poles 120. The cable 118 has a number of steel strength members (not shown) as well as a number of insulated wires 119 and/or coaxial cables 119 to connect with an antenna 122, which is used to bidirectionally connect the traffic signal 106 with a centralized district traffic controller 410 (not shown in FIG. 1) and database 412 (not shown in FIG. 1). The long range ladar sensor 104 may scan in azimuth through a 360 degree arc, or may be one of four long range ladar sensors 104 which are positioned to continuously monitor one of the directions N, S, E, W. The additional detail provided by long range ladar sensor 104 regarding vehicle 108 allows a local traffic controller 406 (not shown in FIG. 1) the option of changing the signal 106 facing vehicle 108 from green to yellow or red, if the vehicle 108 is not showing signs of modifying or delaying progress along an intended path 124 in deference to the position and attitude of pedestrian 112. A short range ladar sensor 102 is also mounted in the assembly 116 at the bottom of four way signal 106 and produces an illumination pattern 126. The short range ladar sensor 102 may also scan rotationally in a 360 degree arc, or may continuously monitor the intersection 114 with a fixed orientation in one of the four directions of the signal 106.

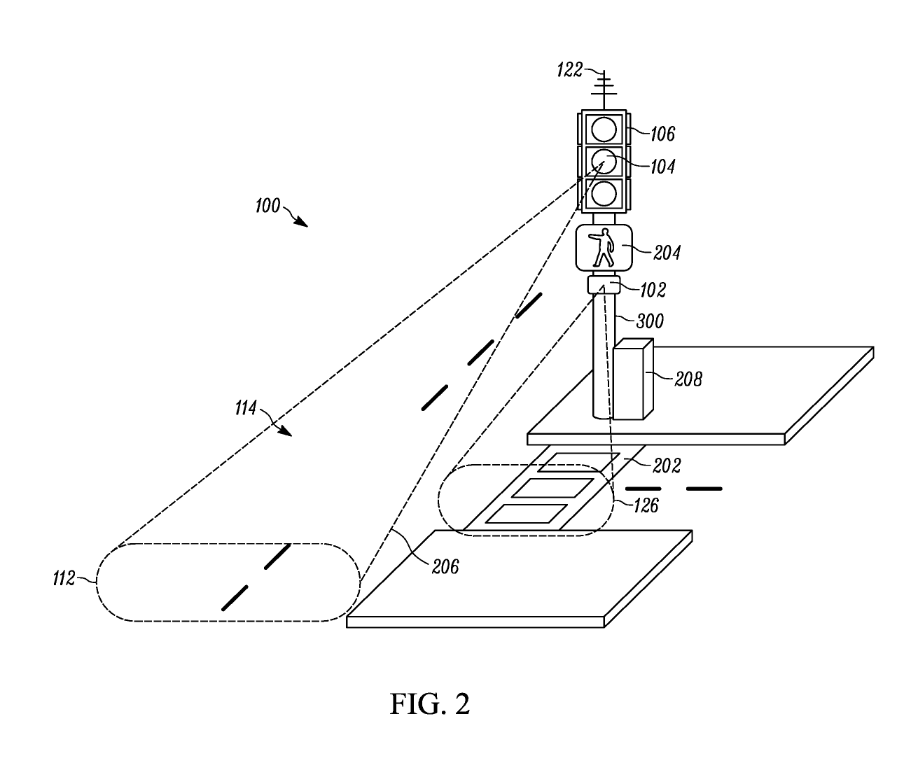

FIG. 2 shows a further exemplary embodiment of the traffic monitoring and control system 100. The illuminating pattern 126 of the short range ladar sensor 102 installed on a vertical pole 200 covers a crosswalk 202 and approaches thereto. A crosswalk signal 204 controls access to the crosswalk 202 through a visible signal, which may be augmented by an audio signal. In this embodiment, the long range ladar sensor 104 is embedded in the yellow signal light (not separately numbered) of traffic control signal 106 and is positioned so illumination pattern 112 monitors the roadway 206 in front. The local traffic controller 406 is connected through wires internal to pole 200 to a pedestal 208, which communicates bidirectionally to the centralized district traffic controller 410 and database 412. The antenna 122 may be used as a backup communication path to the centralized district traffic controller 410 and database 412, or it may be used to communicate directly with vehicles 108 (not shown in FIG. 2) within range of the intersection 114. It is expected most emergency response and law enforcement vehicles 108 will be properly equipped with similar antennas (not shown). In some cases, private vehicles 108 may also be equipped with separate antennas (not shown) designed to receive traffic controls wirelessly from the antenna 122.

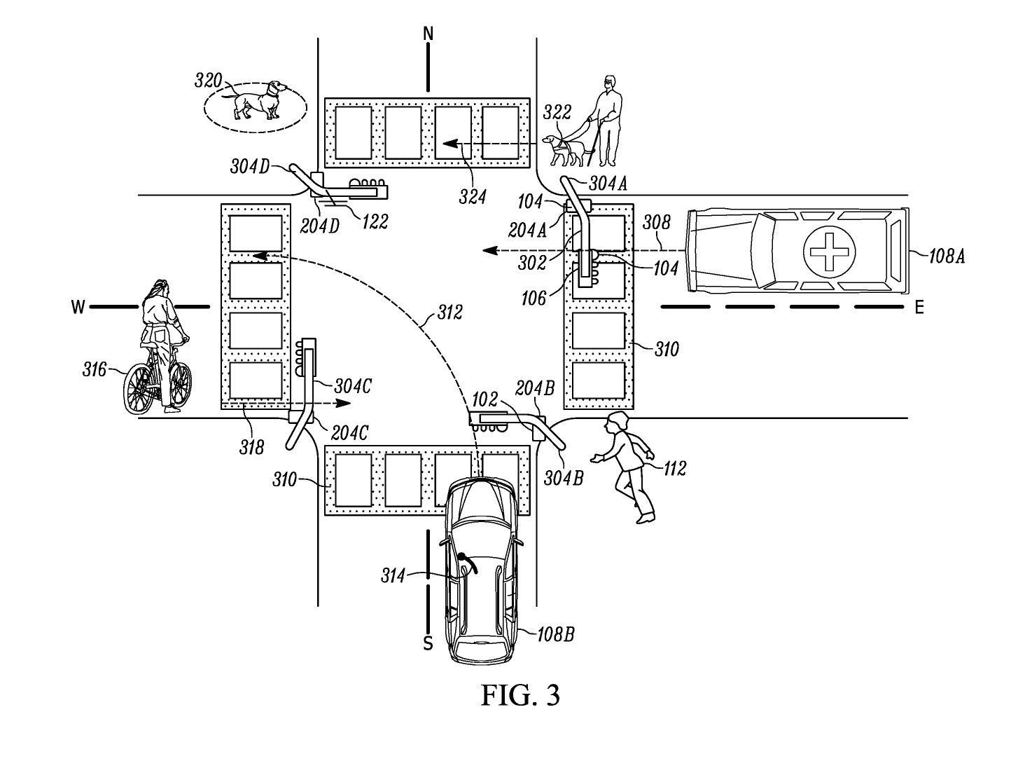

FIG. 3 is a plan view of another exemplary embodiment which illustrates the advantages of the combined use of short range and long range ladar sensors 102, 104 mounted strategically to monitor all the approaches to another intersection 114. The long range ladar sensor 104 is integrated with the traffic signal 106 and mounted on a cantilevered section 302 of vertical pole 304A. The long range ladar sensor 104 monitors the roadway and approaching emergency vehicle 108A travelling on intended path 308. The crosswalk signal 204A integrating the short range ladar sensor 102 controls access to a crosswalk 310 in the path of the emergency vehicle 108A. A pedestrian 112 is detected as moving westward to cross the roadway in crosswalk 310 by the short range ladar sensor 102, so the path is clear for ambulance 108A to continue along intended path 308 in this limited respect. However, the short range ladar sensor 102 integrated with the crosswalk signal 204 is able to identify approaching private vehicle 108B, which is showing intention of crossing the intersection and turning left along intended path 312. This is also confirmed by looking at historical data from the long range ladar sensor 104 mounted to the south facing traffic control signal atop vertical pole 304B. Data from the short range ladar sensor 102 integrated with crosswalk signal 204B shows private vehicle 108B starting to enter the field of view in profile from the left side, so in this case three independent ladar views are available to the local traffic controller 406, which is tasked with estimating the position, velocity, direction, and intended path of private vehicle 108B. The data from each of the three ladar sensors 102 able to view private vehicle 108B is accessed by the local traffic controller 406 which communicates bidirectionally with all ladar sensors 102, 104 and traffic controls in the local traffic control zone through buried wires, fiber optic cables, and/or other communication media. Historical data is accessed from the local traffic zone database 408 when it is useful in tracking the trajectory and estimating the intended path of any objects identified in the local traffic control zone. In the exemplary embodiment, the private vehicle 108B is equipped with a modern bidirectional traffic control radio (not shown) and antenna 314. This radio allows the local traffic controller 406 to change the south facing traffic control signal light from green to red, and to directly take control of the situation by commanding the private vehicle 108B to apply braking controls immediately in the event the driver is not vigilant and prepared. The antenna 122 mounted atop vertical pole 304D may facilitate this radio transmission. Complicating the situation further, a bicyclist 316 without a helmet is identified by the short range ladar sensor 102 integrated with crosswalk signal 204B and mounted to pole 304B. The bicyclist 316 is travelling along intended path 318 which does not intersect with the emergency vehicle 108A. However, the bicyclist 316 is being tracked, does not seem to be taking adequate precautions, and has not reduced speed or moved to the curb. This confirms the local traffic controller 406 decision to halt private vehicle 108B, using the radio command capability to cause private vehicle 108B to brake immediately, while at the same time changing the south facing traffic control signal from green to red.

Continuing with FIG. 3, the short range ladar sensor 102 integrated with crosswalk traffic signal 204C identifies an unleashed canine 320 which seems to be fixated on an approaching canine 322 in harness. Canine 322 has been identified as a working dog in harness by the short range ladar sensor 102 integrated with the crosswalk traffic control signal 204D, and is expected to behave responsibly while waiting to cross on intended path 324. Canine 320 is still a “wild card” at this point, though the high amplitude and frequency sound from sirens of the emergency vehicle 108A should cause the canine 320 to pause long enough for the emergency vehicle 108A to pass. Not all risks have been eliminated, but to the extent possible, the local traffic controller has produced an optimum control output based on the available data. The multiple ladar sensors 102, 104 have enabled with high probability a successful outcome for all trafficants.

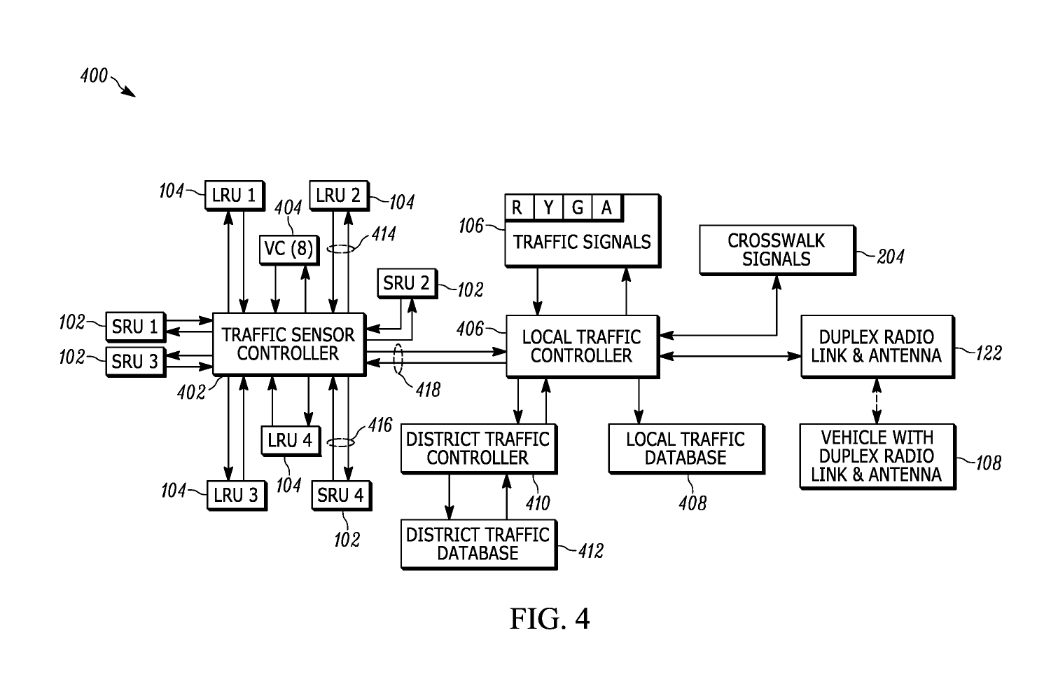

FIG. 4 is a block diagram showing details of a local traffic control zone 400 according to one exemplary embodiment. A traffic sensor controller 402 receives image data from four long range ladar sensors 104, and four short range ladar sensors 102, and eight video cameras 404. Each of the video cameras 404 is mounted coaxially with one of the long range ladar sensors 404 or short range ladar sensors 402 and has an overlapping field of view with the ladar sensor 102, 104 connected to the traffic sensor controller 402. The traffic sensor controller 402 controls both video cameras 404 and ladar sensors 102, 104, receives 2D and 3D image data from same, integrates this data, identifies objects, tracks any identified objects, and passes this information to a local traffic controller 406. The local traffic controller 406 controls the various traffic signals 106, sequencing the red, yellow and green signals and turn arrows according to traffic volume and direction, and with respect to any emergency situations. Local traffic controller 406 also controls the crosswalk signals 204, optimizing wait time and safety for pedestrians, service animals, the visually impaired, and wheelchair or Segway® traffic, and with respect to any emergency situations. Local traffic controller 406 also controls and communicates bidirectionally through a duplex radio link via the antenna 122. In emergency situations, and also when appropriate under normal conditions, local traffic controller 406 may issue warnings and control commands directly to vehicle 108 which has a cooperating duplex radio link (not specifically shown). Local traffic controller 406 may also receive vehicle information and roadway conditions from vehicle 108. The local traffic controller 406 also maintains a local traffic database 408 through bidirectional communications for local reference when tracking objects in the local traffic control zone, and for access by a district traffic controller 410, tasked with controlling the entire traffic control district. District traffic controller 410 maintains a district level traffic data base 412, monitors all of the local traffic databases 408 for traffic volume and direction, plans and coordinates traffic control in all of the subordinate local traffic control zones, and provides for special events, such as presidential motorcades, concerts, sports events, police pursuits, and emergency vehicle routing by sending commands over the same bidirectional fiber optic links which are used to upload information from the local traffic control zones under supervision.

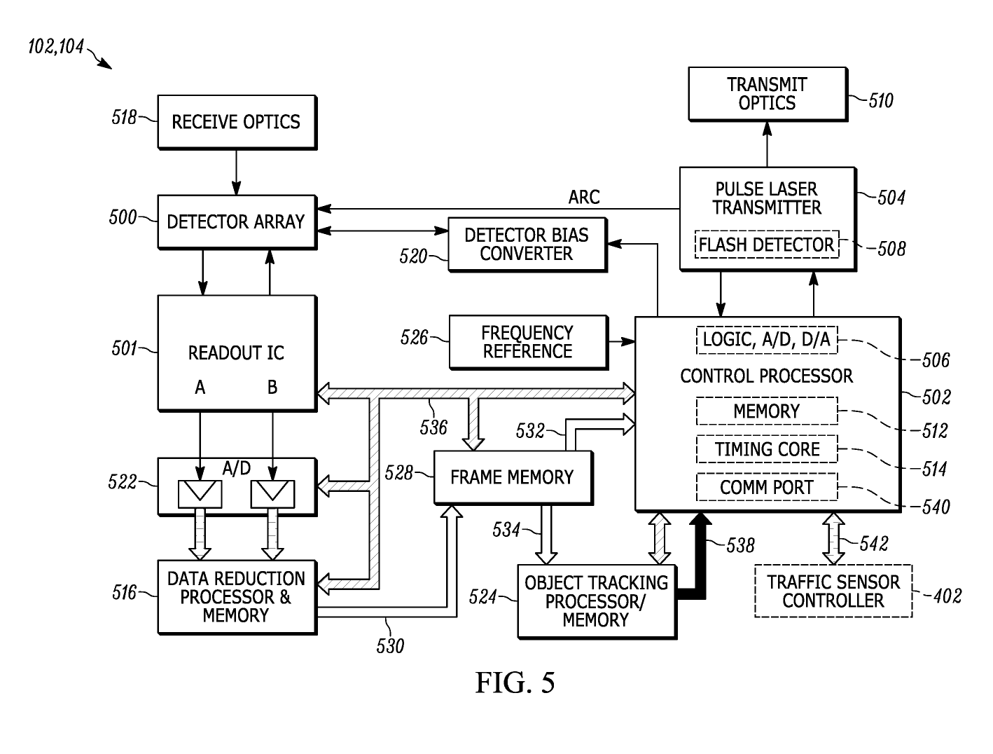

FIG. 5 is a block diagram of a ladar sensor 102, 104 which describes both long range ladar sensors 104 and short range sensors 102 of the embodiments described above. The first embodiment provides a 128×32 or 192×64 detector array 500 of light detecting elements which is stacked atop a ROIC 501 using a hybrid assembly method. In other embodiments, M×N focal plane detector arrays 500 of light detecting elements with M and N having values from 2 to 1024 and greater are anticipated. The functional elements may first be described with respect to the elements of a typical long range ladar sensor 104. A control processor 502 controls the functions of the major components of the ladar sensor 104. Control processor 502 connects to pulsed laser transmitter 504 through bidirectional electrical connections (with interface logic, analog to digital (A/D) and digital to analog (D/A) converters 506) which transfer commands from control processor 502 to pulsed laser transmitter 504 and return monitoring signals from pulsed laser transmitter 504 to the control processor 502. The interface logic, including analog to digital (A/D) and digital to analog (D/A) converters 506, may reside completely or in part on an integrated circuit (not separately shown). A light sensitive diode detector 508, sometimes referred to as a “flash detector”, is placed near a facet of a laser (not shown) of the pulsed laser transmitter 504 so as to intercept a portion of an outbound laser light pulse produced by the pulsed laser transmitter 504. An optical sample of the outbound laser light pulse taken by an optical sampler (not specifically shown) from the front facet of pulsed laser transmitter 504 is routed to a region of the detector array 500500 as an automatic range correction (“ARC”) signal, typically over a fiber optic cable or plastic molded lightguide. The pulsed laser transmitter 504 may be a solid-state laser, monoblock laser, semiconductor laser, fiber laser, or an array of semiconductor lasers. It may also employ more than one individual laser to increase the data rate. In the exemplary embodiment, the pulsed laser transmitter 504 is an array of vertical cavity surface emitting lasers (“VCSELs”). In another embodiment, the pulsed laser transmitter 504 is a disc shaped solid state laser of erbium doped phosphate glass pumped by 976 nanometer semiconductor laser light. The pulsed laser transmitter 504 may also be a rod shaped solid state laser of Nd:YAG pumped by 808 nanometer semiconductor laser light.

In operation, the control processor 502 initiates a laser illuminating pulse by sending a logic command or modulation signal to pulsed laser transmitter 504, which responds by transmitting an intense burst of laser light through transmit optics 510. In the case of a Q-switched solid state laser based on erbium glass, neodymium-YAG, or other solid-state gain medium, a simple bi-level logic command may start the pump laser diodes emitting into the gain medium for a period of time which will eventually result in a single flash of the pulsed laser transmitter 504. In the case of a semiconductor laser which is electrically pumped, and may be modulated instantaneously by modulation of the current signal injected into the laser diode, a modulation signal of a more general nature is possible, and may be used with major beneficial effect. The modulation signal may be a flat-topped square or trapezoidal pulse, or a Gaussian pulse, or a sequence of pulses. The modulation signal may also be a sinewave, gated or pulsed sinewave, chirped sinewave, or a frequency modulated sinewave, or an amplitude modulated sinewave, or a pulse width modulated series of pulses. The modulation signal is typically stored in memory 512 as a lookup table of digital memory words representative of analog values. The lookup table is read out in sequence by the control processor 502 and converted to analog values by the onboard digital-to-analog (D/A) converter 506, and passed to the pulsed laser transmitter 504 driver circuit. The combination of a lookup table stored in memory 512 and the D/A converter 506, along with the necessary logic circuits, clocks, and timers 514 resident on control processor 502, together comprise an arbitrary waveform generator (“AWG”) circuit block (not separately numbered). The AWG circuit block may alternatively be embedded within a laser driver (not shown) as a part of the pulsed laser transmitter 504. The transmit optics 510 diffuse the high intensity spot produced by pulsed laser transmitter 504 substantially uniformly over the desired field of view to be imaged by the ladar sensor 102, 104. An optical sample of the transmitted laser pulse (i.e., the ARC signal) is also sent to the detector array 500 via optical fiber or plastic molded lightguide. A few pixels in a small region of detector array 500 are illuminated with the ARC signal, which establishes a zero time reference for the timing circuits in the ROIC 501. Each unit cell of the ROIC 501 has an associated timing circuit (not shown) which is started counting by an electrical pulse derived from the ARC signal. Alternatively, the flash detector signal produced by the flash detector 508 may be used as a zero reference in a second timing mode. Though the ARC signal neatly removes some of the variable delays associated with transit time through the detector array 500, additional cost and complexity may result. Given digital representations of the image frames, the same task may be handled in software/firmware by a capable embedded processor such as a data reduction processor 516. When some portion of the transmitted laser pulse is reflected from a feature in the scene in the field of view of the ladar sensor 102, 104, it may be incident upon receive optics 518, typically comprising a lens assembly (not shown) and in some cases, an array of microlenses (not shown) atop detector array 500. Other embodiments use enhanced detectors which may not require the use of microlenses. Other embodiments of receive optics 518 may employ diffractive arrays to collect and channel the incoming light to the detector array 500 individual elements. Pulsed laser light reflected from a feature in the scene in the field of view of receive optics 518 is focused onto an individual detector element (not shown) of the detector array 500. This reflected laser light optical signal is then detected by the affected detector element and converted into an electrical current pulse which is then amplified by an amplifier circuit (not shown) of the unit cell electrical circuit (not shown) of the readout integrated circuit 501, and the time of flight measured. Thus, the range to each reflective feature in the scene in the field of view is measurable by the ladar sensor 102, 104. The detector array 500 and readout integrated circuit 501 may be an M×N or N×M sized array.

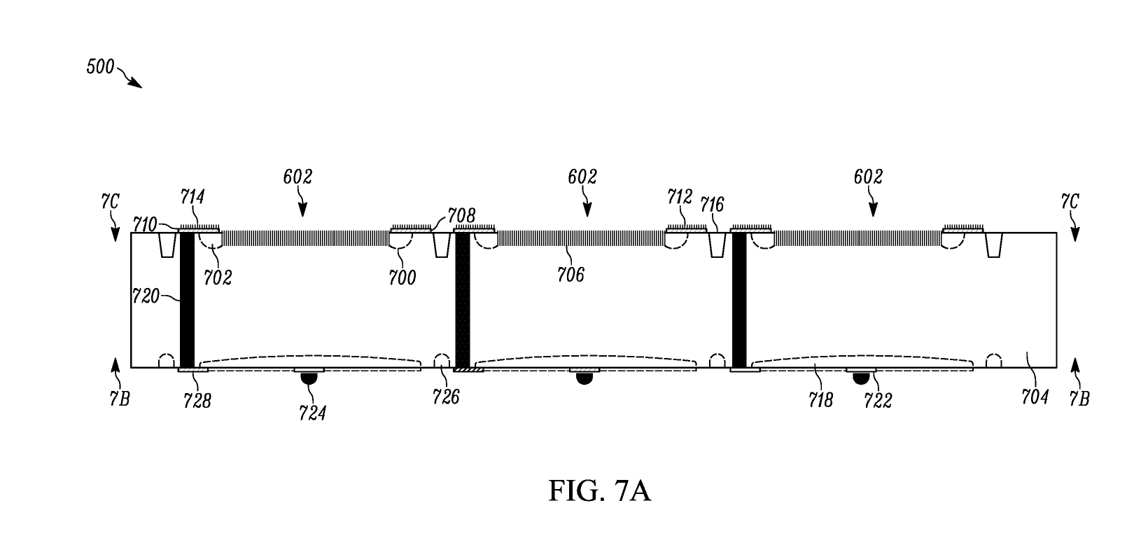

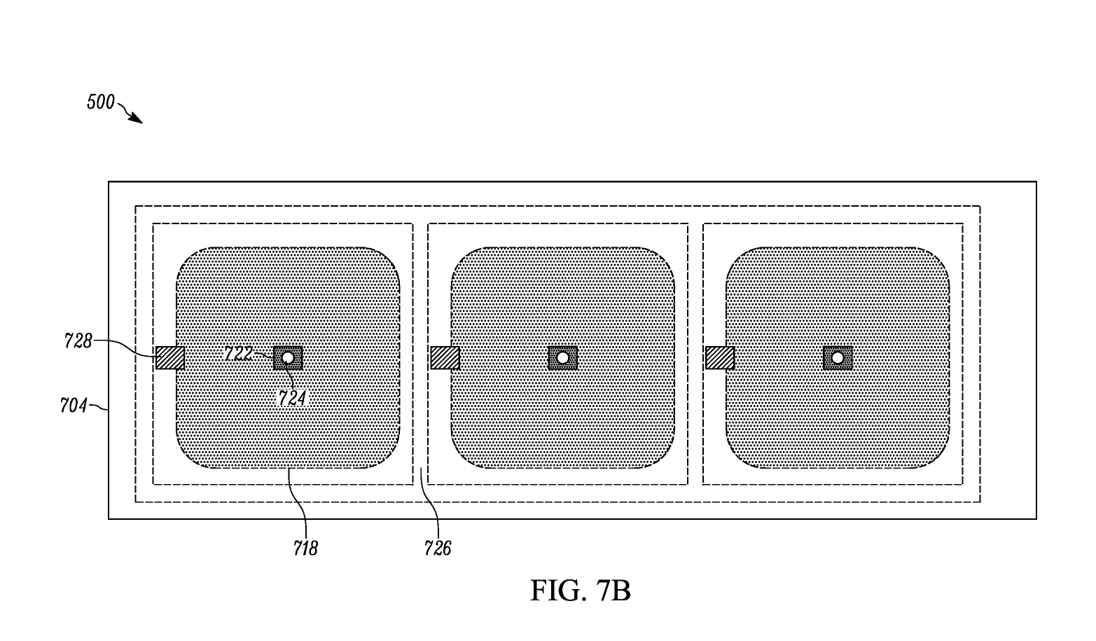

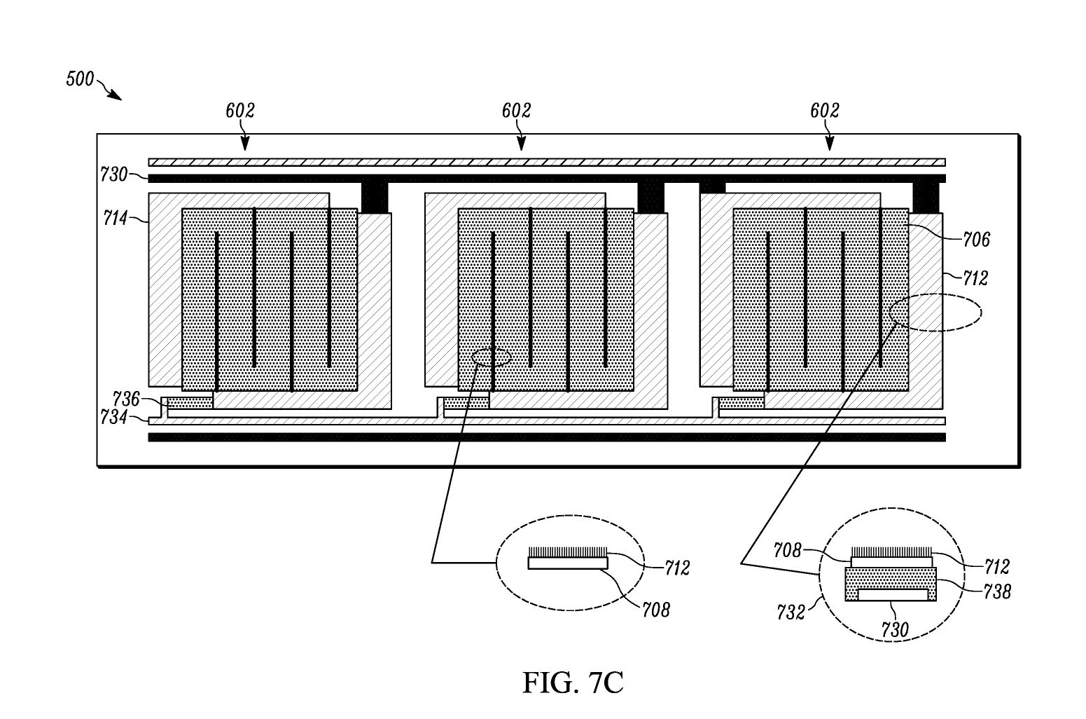

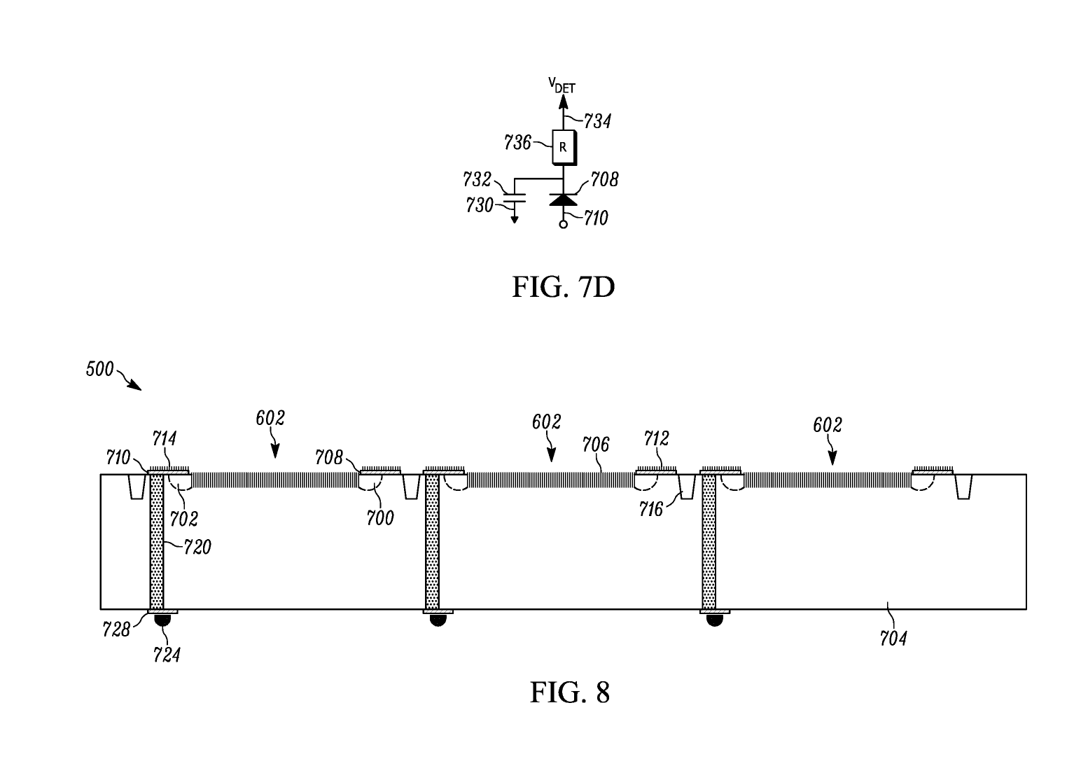

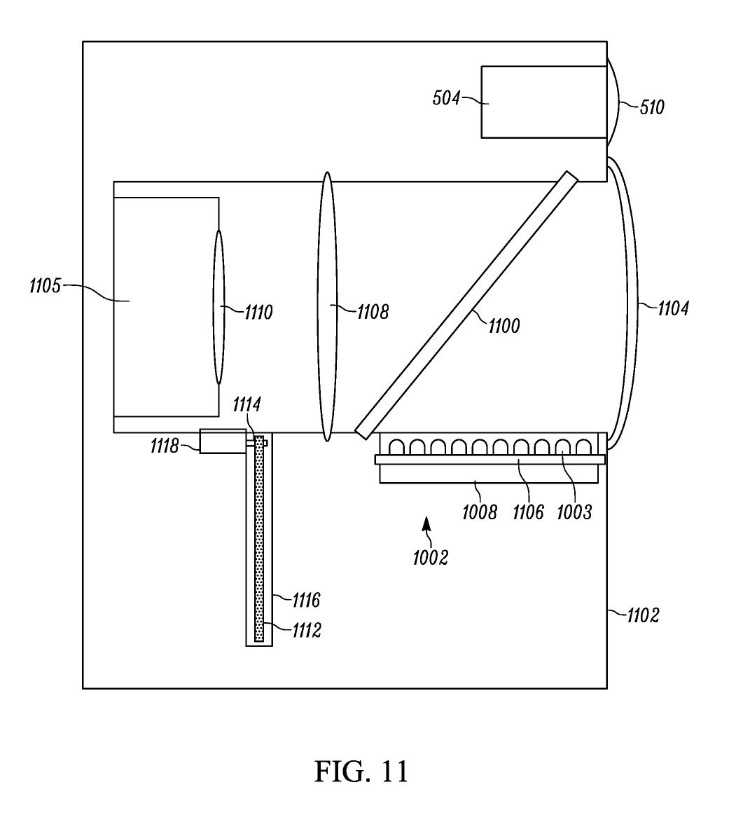

Continuing with FIG. 5, receive optics 518 may be a convex lens, spherical lens, cylindrical lens, or diffractive grating array. An optional mechanical shutter (not shown in FIG. 5) may be used by control processor 502 to calibrate the system or protect the detector array 500. This capability is described in detail in association with FIG. 11, as described in greater detail below. The receive optics 518 collect the light reflected from the scene and focus the collected light on the detector array 500. In one exemplary embodiment, as described in greater detail below, the detector array 500 is formed in a thin film of black silicon 706 on a silicon substrate 704 as described in FIG. 7A. In another embodiment, detector array 500 is formed in a thin film of indium gallium arsenide (“InGaAs”) (not shown) deposited epitaxially atop an indium phosphide (“InP”) semiconducting substrate. The use of black silicon 706 in the detector array 500 allows for lower cost detector arrays and basic solder techniques for flip-chip bonding, as opposed to InGaAs on InP substrates with indium bump bonding as used in some prior art designs. In some embodiments, the detector array 500 includes a set of cathode contacts 708 exposed to the light and a set of anode contacts 710 electrically connected to the supporting the ROIC 501 through a number of indium bumps deposited on the detector array 500. The cathode contacts 708 of the individual detectors of detector array 500 are then connected to a detector bias voltage grid on the illuminated side of the array. Each anode contact of the detector elements of detector array 500 is thus independently connected to an input of a unit cell electronic circuit of the ROIC 501. This traditional hybrid assembly of detector array 500 and the ROIC 501 may still be used, but new technology may reduce inter-element coupling, or crosstalk, and reduce leakage (i.e., “dark”) current and improve efficiency of the individual detector elements of detector array 500. Other detector array structures are developed herein and described in association with FIGS. 7A-D, 8, and 9.

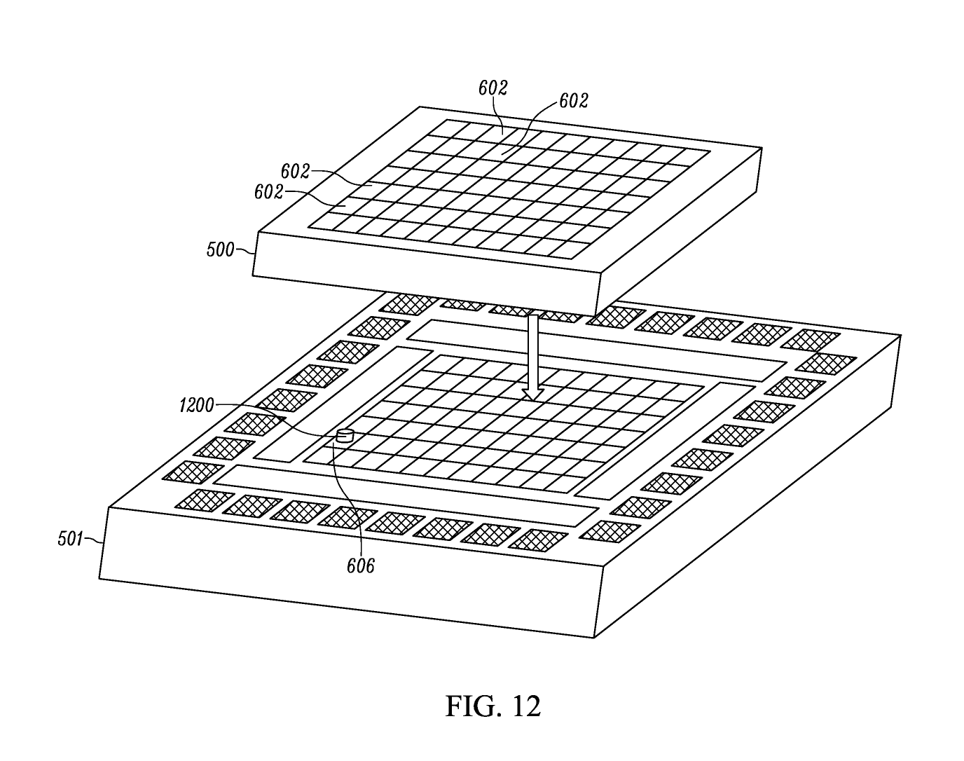

As stated above, the ROIC 501 comprises a rectangular array of unit cell electrical circuits. Each unit cell has the capability of amplifying a low level photocurrent received from an optoelectronic detector element of detector array 500, and sampling the amplifier output. Typically the unit cell is also capable of detecting the presence of an electrical pulse in the pixel amplifier output associated with a light pulse reflected from the scene and intercepted by the detector element of detector array 500. The detector array 500 may be an array of avalanche photodiodes capable of photoelectron amplification. The detector array 500 elements may be P-intrinsic-N (“PIN”) photodiodes or N-intrinsic-P (“NIP”) photodiodes with the dominant carrier being holes or electrons respectively. In the case of an NIP detector structure, the corresponding ROIC 501 would have the polarity of the bias voltages and amplifier inputs adjusted accordingly. The hybrid assembly (not numbered) of detector array 500 and ROIC 501 of one exemplary embodiment is shown in FIG. 12, and the assembly is then mounted to a supporting circuit assembly (not shown), typically on a FR-4 substrate or ceramic substrate. The supporting circuit assembly typically supplies conditioned power, a reference clock signal, calibration constants, and selection inputs for the readout column and row, among other support functions, while receiving and registering range and intensity outputs from the ROIC 501 for the individual elements of the detector array 500. Many of these support functions may be implemented in Reduced Instruction Set Computer (“RISC”) processors which reside on the same circuit substrate.

Referring again to FIG. 5, a detector bias converter circuit 520 applies a time varying detector bias to the detector array 500 which provides optimum detector bias levels to reduce the hazards of saturation in the near field of view of detector array 500, while maximizing the potential for detection of distant objects in the field of view of detector array 500. The contour of the time varying detector bias supplied by detector bias converter 520 is formulated by the control processor 502 based on feedback from the data reduction processor 516, indicating the reflectivity and distance of objects or points in the scene in the field of view of the detector array 500. The control processor 502 also provides several clock and timing signals from the timing core 514 to the ROIC 501, the data reduction processor 516, analog-to-digital converters 522, an object tracking processor 524, and their associated memories. The control processor 502 may utilize a temperature stabilized or temperature compensated frequency reference 526 to generate a variety of clocks and timing signals. The temperature stabilized frequency reference 526 may be a temperature compensated crystal oscillator (TCXO), dielectric resonator oscillator (DRO), or surface acoustic wave device (SAW). The timing core 514 resident on the control processor 502 may include, but is not limited to, a high frequency tunable oscillator, programmable prescaler dividers, phase comparators, and error amplifiers.

Continuing with FIG. 5, control processor 502, data reduction processor 516, and object tracking processor 524 may each have an associated memory (not separately shown) for storing programs, data, constants, and the results of operations and calculations. These memories, each associated with a companion digital processor, may include ROM, EPROM, or other non-volatile memory such as flash. They may also include a volatile memory such as SRAM or DRAM, and both volatile and non-volatile memory may be integrated into each of the respective processors. In the exemplary embodiment, a common frame memory 528 serves to hold a number of frames, each frame being the image resulting from a single laser pulse. Both the data reduction processor 516 and object tracking processor 524 may perform three-dimensional (“3D”) image processing, to reduce the load on a scene processing unit normally associated with a higher level processor, for example, the traffic sensor controller 402.

Two modes of data collection are typically implemented, the first being SULAR, or a progressive scan in depth. Each laser pulse typically results in 20 “slices” of data, similar to a CAT scan, and each “slice” may be stored as a single page in the common frame memory 528. With each pixel sampling at a 2 nanosecond interval, the “slices” are each a layer of the image space at roughly 1 foot (30 cm) differences in depth. The 20 slices represent a frame of data, and the sampling for a succeeding laser pulse may be started at 20 feet (610 cm) further in depth, so that the entire image space up to 1000 feet (305 m) in range or depth, may be swept out in a succession of 50 laser illuminating pulses, each laser pulse response having 20 “slices” of data held in a single frame entry. In some cases, the frame memory may be large enough to hold all 50 frames of data. In another exemplary embodiment, super-sized frames of 128 slices for a short range 128×32 imager are employed, which contain all the data to a depth of nearly 128 feet (39 meters). In yet another exemplary embodiment, super-sized frames of 384 slices for a long range 192×64 imager are employed, which contain all the data to a depth of nearly 383 feet (117 meters). The number of slices stored could be enough to map out any relevant distance, with no trigger mode operation required. The reduction of the data then takes place in an external computer, as in the case of data taken to map an underwater surface, or a forest with tree cover, or any static landscape, where sophisticated post-processing techniques in software may yield superior accuracy or resolution.

A second data acquisition mode is the TRIGGER mode, where the individual pixels each look for a pulse response, and upon a certain pulse threshold criteria being met, the 20 analog samples bracketing the pulse time of arrival are retained in the pixel analog memories, and a running digital counter is frozen with a nominal range measurement. The 20 analog samples are output from each pixel through the “A” and “B” outputs of ROIC 501, which represent the interleaved row or column values of the 128×32 pixels of the present design. The “A” and “B” outputs are analog outputs, and the analog samples presented there are converted to digital values by the dual channel analog-to-digital (A/D) converter 522. Interleaving the outputs means one of the outputs (“A”) reads out the odd numbered lines of the ROIC 501, and the other output (“B”) reads out the even numbered lines of the ROIC 501. Larger detector arrays 500 and ROICs 501 may have more than two analog outputs. The digital outputs of the A/D converters 522 connect to the inputs of the data reduction processor 516. A/D converters 522 may also be integrated into the ROIC 501. The digital outputs are typically 10 or 12 bit digital representations of the uncorrected analog samples measured at each pixel of the ROIC 501, but other representations with greater or fewer bits may be used, depending on the application. The rate of the digital outputs depends upon the frame rate and number of pixels in the array.

In the TRIGGER mode of data collection, a great deal of data reduction has already transpired, since the entire range or depth space may be swept out in the timeframe of a single laser pulse, and the data reduction processor 516 would only operate on the 20 analog samples stored in each unit cell in order to refine the nominal range measurement received from each pixel (unit cell) of the array. The data reduction processor 516 refines the nominal range measurements received from each pixel by curve fitting of the analog samples to the shape of the outgoing laser illuminating pulse, which is preserved by the reference ARC pulse signal. These pulses are typically Gaussian, but may be square, trapezoidal, haversine, sinc function, etc., and the fitting algorithms may employ convolution, Fourier analysis, Least Squares analysis, or fitting to polynomials, exponentials, etc. The range measurements may also be refined by curve fitting to a well known reference pulse characteristic shape. In TRIGGER acquisition mode, the frame memory 528 only needs to hold a “point cloud” image for a single illuminating laser pulse. The term “point cloud” refers to an image created by the range and intensity of the reflected light pulse as detected by each pixel of the 128×32 array of the present design. In TRIGGER mode, the data reduction processor 516 serves mostly to refine the range and intensity (“R&I”) measurements made by each pixel prior to passing the R&I data to the frame memory 528 over a data bus 530, and no “slice” data or analog samples are retained in memory independently of the R&I “point cloud” data in this acquisition mode. Frame memory 528 provides individual or multiple frames, or full point cloud images, to the control processor 502 over another data bus 532, and to the optional object tracking processor 524 over data bus 534 as required.

Continuing with FIG. 5, the data reduction processor 516 and control processor 502 may each be a reduced instruction set (“RISC”) digital processor with hardware implementation of integer and floating point arithmetic units. The object tracking processor 524 may also be a RISC processor, but may in some cases be a processor with greater capability, suitable for highly complex graphical processing. The object tracking processor 524 may have in addition to hardware implemented integer and floating point arithmetic units, a number of hardware implemented matrix arithmetic functions, including, but not limited to, matrix determinant, matrix multiplication, and matrix inversion. In operation, the control processor 502 controls the detector bias converter 520, ROIC 501, A/D converters 522, frame memory 528, data reduction processor 516 and object tracking processor 524 through a bidirectional control bus 536 which allows for the control processor 502, acting as a “master” unit, to pass commands on a priority basis to the dependent peripheral functions such as the detector bias converter 520, ROIC 501, A/D converters 522, frame memory 528, data reduction processor 516, and object tracking processor 524. The bidirectional control bus 536 also serves to return status and process parameter data to the control processor 502 from these same functional blocks. The data reduction processor 516 refines the nominal range data and adjusts each pixel intensity data developed from the digitized analog samples received from A/D converters 522, and outputs a full image frame via the unidirectional data bus 530 to frame memory 528, which is a dual port memory having the capacity of holding several frames to several thousands of frames, depending on the application. Object tracking processor 524 has internal memory with sufficient capacity to hold multiple frames of image data, allowing for multi-frame synthesis processes, including video compression, single frame or multi-frame resolution enhancement, statistical processing, and object identification and tracking. The outputs of object tracking processor 524 are transmitted through a unidirectional data bus 538 to a communications port 540, which may be resident on the control processor 502. All slice data, range and intensity data, control, and communications then pass between communications port 540 and the centralized traffic sensor controller 402, through bidirectional connections 542. Power and ground connections (not shown) may be supplied through an electromechanical interface. Bidirectional connections 542 may be electrical or optical transmission lines, and the electromechanical interface may be a DB-25 electrical connector, or a hybrid optical and electrical connector, or a high reliability connector configured to carry signals bidirectionally for the ladar sensor 102, 104. Bidirectional connections 542 may also connect to traffic sensor controller 402 in the instance of a crosswalk signal which may have an integral short range ladar sensor 102. Bidirectional connections 542 may be high speed serial connections such as Ethernet, Universal Serial Bus (USB), or Fibre Channel, or may also be parallel high speed connections such as Infiniband, etc., or may be a combination of high speed serial and parallel connections, without limitation to those listed here. Bidirectional connections 542 also serve to upload information to control processor 502, including program updates for data reduction processor 516, object tracking processor 524, and reference data derived from a district level traffic database, as well as application specific control parameters for the remainder of the ladar sensor 102, 104 functional blocks.

The short range ladar sensors 102 typically employ a semiconductor laser, which may be modulated in several different ways. The long range ladar sensors 104 typically employ a q-switched solid state laser, which produces a single output pulse with a Gaussian profile. The pulse shape of a solid state laser of this type is not easily modulated, and therefore must be dealt with “as is” by the receiver section of a long range ladar sensor 104. The operations of short range ladar sensor 102 of the type which are used with crosswalk signals 204 are the same as the operations of the long range ladar sensor 104 with some exceptions. The long range ladar sensor 104 and short range ladar sensor 102 may differ only in the type of laser employed and the type of laser modulation. The transmit optics 510 and receive optics 518 may also differ, owing to the narrower angular field of view for the long range ladar sensor 104. Differences in the transmitted laser pulse modulation between the long range ladar sensor 104 and short range ladar sensor 102 may be accommodated by the flexible nature of the ROIC 501 sampling modes, and the data reduction processor 516 programmability. The traffic sensor controller 402 may have a number of connector receptacles generally available for receiving mating connector plugs from USB, Ethernet, RJ-45, or other interface connection, and which may alternatively be used to attach long range ladar sensor 104 or short range ladar sensor 102 of the type described herein.

Continuing with FIG. 5, it is useful to discuss a short range ladar sensor 102 variant. In a short range ladar sensor 102, considerably less optical transmit power is required, allowing for the use of a semiconductor laser and multi-pulse modulation schemes. One example of a semiconductor laser is the vertical cavity surface emitting laser (VCSEL), used in a preferred embodiment because of a number of preferential characteristics. A VCSEL typically has a circular beam profile, and has lower peak power densities at the aperture. VCSELs also require fewer secondary mechanical operations, such as cleaving, polishing, etc., and may be formed into arrays quite easily. The use of a semiconductor laser allows for the tailoring of a drive current pulse so as to produce a Gaussian optical pulse shape with only slight deviations. The VCSEL response time is in the sub-nanosecond regime, and the typical pulse optical width might be 5-100 nanoseconds at the half power points. In the diagram of FIG. 5, the VCSEL and laser driver would be part of the pulsed laser transmitter 504, and the desired pulse or waveshape is produced by a digital-to-analog converter 506 which has a typical conversion rate of 200-300 MHz, so any deviations in the output pulse shape from the Gaussian ideal may be compensated for in the lookup table in memory 512 associated with control processor 502, which serves as the digital reference for the drive current waveform supplied to the laser driver within pulsed laser transmitter 504 by the D/A converter 506. A Gaussian single pulse modulation scheme works well at short ranges, given the limited optical power available from a VCSEL. Extending the range of a VCSEL transmitter may be done using more sophisticated modulation schemes such as multi-pulse sequences, sine wave bursts, etc. The VCSEL and modulation schemes as described herein with reference to the short range ladar sensor 102 are an alternative to the solid state laser typically used in a pulsed laser transmitter 504 of the long range ladar sensor 104. The use of a VCSEL array in the pulsed laser transmitter 504 has the potential to reduce cost, size, power consumption, and/or enhance reliability. When referring to the major functions of the ladar sensor 102, 104 of FIG. 5, it is sometimes convenient to refer to the “optical transmitter” as those functions which support and/or create the burst of light for illuminating the scene in the field of view. These elements would typically be the control processor 502 which starts the process, frequency reference 526, pulsed laser transmitter 504, and transmit optics 510. The term “optical receiver” may be used to refer to those elements necessary to collect the light reflected from the scene in the field of view, filter the received light, convert the received light into a plurality of pixelated electrical signals, amplify these pixelated electrical signals, detect the pulses or modulation thereon, perform the range measurements, and refine or reduce the received data. These functions would include the receive optics 518, detector array 500, ROIC 501, A/D converters 522, detector bias converter 520, frame memory 528, object tracking processor 524, and the data reduction processor 516.

Referring again to FIG. 4, the traffic sensor controller 402 is an intermediate function which integrates all of the 3D data captured by the various ladar sensors 102, 104 installed in the local traffic control zone 400, typically comprising an intersection, while monitoring the status of these sensors and providing control inputs thereto. The traffic sensor controller 402 may be subsumed as a piece of software or hardware into the local traffic controller 406 in some traffic control zones. The traffic sensor controller 402 transmits commands to the short range ladar sensors 102, and to the long range ladar sensors 104. Optical fibers 414 and/or wires 416 provides the physical media for the transfer of the commands from the traffic sensor controller 402 to the various ladar sensors 102, 104. 3D data and status signals are returned from the ladar sensors to the traffic sensor controller 402 through optical fibers 414 and wires 416. Likewise, command signals are sent to a number of 2D cameras 404, and status and image data are returned from the 2D cameras via wires and fiber optic cable to traffic sensor controller 402. The long range sensors 104 connect through bidirectional connections which logically include the transmitters and receivers within each long range sensor unit, the physical media of optical fiber 414, and the transmitters and receivers of the traffic sensor controller 402. Typically fiber optic connections 414 are data grade multimode fiber. Each short range sensor unit 102 connects through a set of bidirectional connections which logically include the transmitters and receivers within each short range sensor unit, the physical media of wire connections 416, and the transmitters and receivers of the traffic sensor 402. Typically wire connections 416 are shielded twisted pair (STP). The traffic sensor controller 402 may have a scene processing capability which allows it to combine the 3D frames received from each of the operational ladar sensors into a composite 3D map of the entire space in the field of view and may also merge the 3D map with 2D image data received from a number (8) of 2D still or video cameras 404 to provide enhanced resolution, color, and contrast. The addition of conventional 2D still or video cameras 404 provide the system with enhanced capability for object identification. Traffic sensor controller 402 receives status data from the ladar sensors indicating laser temperature, transmitted laser pulse power and pulse shape, receiver temperature, background light levels, etc. and makes decisions about adjustments of global input parameters to the various ladar sensors being controlled. Global settings for detector bias, trigger sensitivity, capture modes, filter bandwidth, etc. may be sent from traffic sensor controller 402 to a given ladar sensor which may override the local settings originally set or adjusted by a local control processor 502 residing within the ladar sensor. The traffic sensor controller 402 may also have internal a non-volatile memory to provide a storage location for the programs which run on the traffic sensor controller 402, and which may be used to store status data and other data useful at start-up of the system. Residing on traffic sensor controller 402 is a communications port for passing data and control commands and status signals over bidirectional connections 418. The communications port is typically an Ethernet port or Gigabit Ethernet port, but may be a USB, IEEE1394, Fibre Channel, or other type data port, and is connected to provide bidirectional communications with the local traffic controller 406. Connections 418 may be optical, electrical, or a combination of both, and include any transmitters and receivers necessary to condition and transmit the data signals in both directions. The 3D range data derived from the reflections of the modulated laser light allows for an initial object model to be determined, and for some object identification to take place in a processor of the individual ladar sensors 102, 104 installed in the local traffic control zone. FIGS. 1-3 show typical installation and sighting, but other locations and viewing angles are appropriate in many instances, and those skilled in the art will find many other ways to improve the overall coverage and efficiency of the intersection design. Refinements of object models identified at the individual ladar sensor level may be made at higher levels in the system where data from several sensors may be integrated with the data from previous frames. This capability of looking at historical data as well as current data, allows for some road hazards and collision threats to be viewed from a plurality of angles as the situation progresses, thus eliminating some shadows, while additional shape information is developed from the multiple angles of observation.

The duplex radio link 122 connects to the local traffic controller 406, and may communicate directly with vehicles 108 in range, receiving position, speed, direction, and vehicle specific information from vehicle 108, to facilitate collision avoidance and the free flow of traffic. The duplex radio link 122 may also transmit local positional references, road data, weather conditions, and other information important to the operations of the vehicle 108 from the local traffic database 408. The vehicle 108 may also provide vehicle status and road conditions updates to the local traffic database via radio link, allowing the local traffic data base 408 and district traffic data base 412 to be augmented by any vehicle 108 equipped with ladar sensors and a radio link.

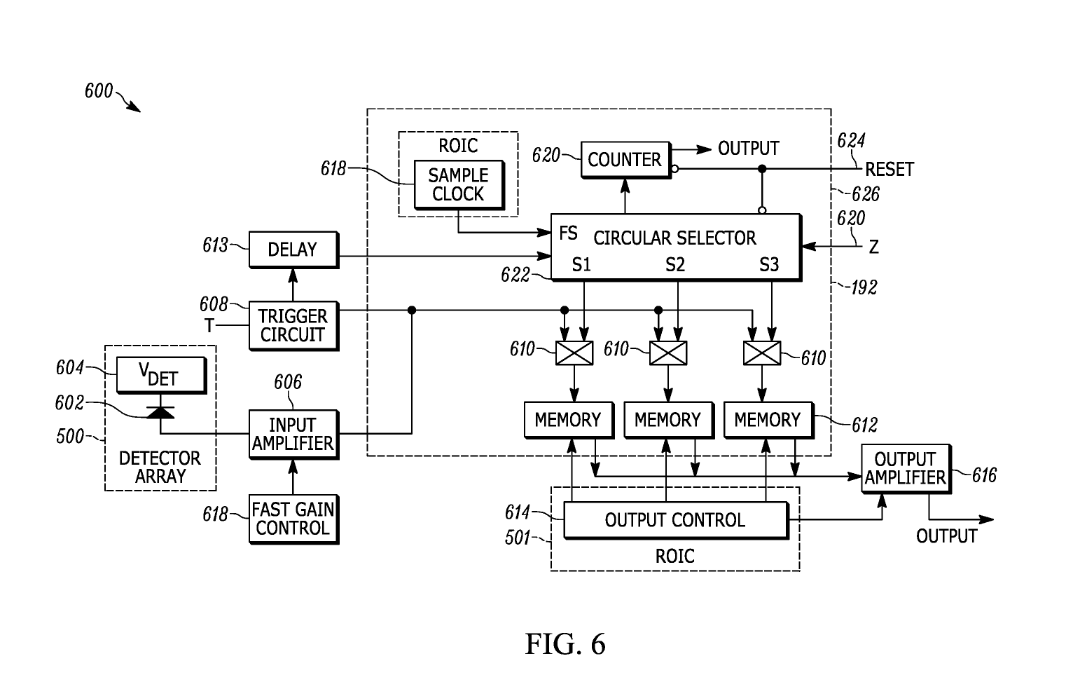

The unit cell electronics 600 depicted in FIG. 6 is well adapted to work with a Gaussian single pulse modulation scheme, and works advantageously with other modulation schemes as well, including sequences of flat-topped pulses, Gaussian, or otherwise shaped pulses. These pulses may be of varying width and spacing, in order to reduce range ambiguities, and may also be random pulse sequences, or in other cases, Barker coded pulse sequences. In the typical operation of the short range ladar sensor 102 having a semiconductor laser producing a single Gaussian output pulse, some portion of the pulsed laser light reflected from a surface in the field of view of the short range ladar sensor 102 is concentrated and focused by receive optics 518 and falls on an individual detector element 602 of the detector array 500. The individual detector element 602 is typically a PIN diode, but may be an avalanche photodiode, NIP diode, or other structure. Each individual detector element 602 of detector array 500 is formed in a semiconducting film comprised of silicon, indium gallium arsenide, indium gallium arsenide phosphide, aluminum gallium arsenide, indium gallium nitride, or other semiconducting compound appropriate to the wavelength of operation. Each individual detector element 602 is biased with a voltage by a bias voltage distribution network VDET 604. The reflected light signal incident upon the individual detector element 602 is converted to an electronic signal, typically a photocurrent, and amplified by input amplifier 606, typically a transimpedance amplifier. The output of input amplifier 606 is distributed to a trigger circuit 608 as well as a plurality of analog sampling gates 610. Each analog sampling gate 610 has an output connected to an analog memory cell 612. The trigger circuit 608 is typically a threshold voltage comparator, set to trigger when a pulse is received which exceeds a predetermined magnitude, though other pulse detection schemes may be used. After a programmable delay through delay circuit 613, the state of circular selector 622 is frozen by the logic transition of the trigger circuit 608 output if the unit cell 600 is being operated in TRIGGER mode. Prior to the detection of a received pulse by trigger circuit 608, the sample clock 618 causes the state of circular selector 622 to advance, enabling one of the sampling control outputs S1-S3, which in turn causes a sampling of the input amplifier 606 output by one of the sampling gates 610. The sampling gates 610 are typically field effect transistors configured as transmission gates, effectively an analog switch. Each analog switch 610 is connected to a small storage capacitor 612, which serves as an analog memory cell. Briefly connected through the sampling gate 610 to the output of input amplifier 608, the small storage capacitor 612 rapidly charges to the voltage level of input amplifier 606, and an analog sample is taken. The sampling gates 610 are then deselected, and become very high impedance, allowing the small storage capacitors 612 to retain the analog sample of the input voltage until selected by an output control 614 and read out through an output amplifier 616. The number of transitions of a sample clock 618 is counted by a counter 620, as a circular selector 622 outputs a logic transition to the counter 620 for every cycle of the sampling clock after the release of an active low reset line 624. Circular selector 622 may cycle through outputs S1-S3 in order, or may have a different sequence, depending on the programming. A second circular selector (not shown) and a second sample clock (not shown) may operate in parallel, along with a second counter (not shown), additional analog sampling gates (not shown) and analog memory cells (not shown).

The combination of sample clock 618, counter 620, circular selector 622, sampling gates 610, and memory cells 612 may be termed a unit cell sampling structure 626, indicated by the short dashed line border. Two, three, or more of these sampling structures 626 may be operated in parallel on the output of input amplifier 606. The advantage of having multiple sampling structures 626 is it will allow the capture of multiple return pulses in the same sampling interval without providing for a massive sample record. For example, a reflective target behind a thick window will produce three distinct pulses, one at the first air-glass interface, a second pulse reflected from the distal face of the window, and a third pulse of major amplitude from the reflective target. In such a case, where a 200 m distance must be imaged, it would require a single channel sample record of 1200 ns, which could be realized by 600 sampling gates 610 and memory cells 612 when sampling at a 2 nanosecond (“ns”) interval. Although shown in FIG. 6 as three sampling gates 610 and three analog memory cells 612, the number of sampling gates 610 and analog memory cells 612 could be several hundred or more on some ROICs 501.

Once all of the analog sample data has been taken, a control command from the control processor 502 initiates a readout cycle by activating output control 614 and output amplifier 616 to readout the contents of the analog memory cells 612 in a predetermined order. A fast gain control 618 allows for an increase of dynamic range for input amplifier 606. Fast gain control 618 can be adjusted between successive pulses, or may be used within a sample period, creating a minimum gain input amplifier 606 at short ranges in the first part of a sampling interval, and increasing to a maximum gain setting at the end of a sampling period, near the range limit of the receiver. Having low gain at short ranges can be useful to prevent “blooming” across the detector array 500 in the case of retro-reflectors, and having a higher gain later in the sampling period, and near the range limit means low reflectance objects may still be detectable.

In a typical short range ladar sensor 102, and assuming a 1 cm² VCSEL array with a 5 kW/cm² power density, and depending upon the reflectivity of the objects in the field of view, and the responsivity and excess noise of the detector array 500, the effective range of a Gaussian single pulse modulation scheme may be in the range of 20 meters, using a simple threshold detection technique. Without resorting to a large VCSEL array, which may be expensive and require a large discharge capacitor to supply a large current pulse, more sophisticated modulation and detection techniques can be used to create additional processing gains, to effectively increase the signal-to-noise ratio, and thus extend the range of the short range ladar sensor 102 without requiring an increase in peak power.

In a first modulation scheme, which produces a Gaussian single pulse modulation, a detection technique may be employed which uses the digitized analog samples from each unit cell electrical circuit, and processes these samples in a digital matched filter to find the centroid of the received pulse, resulting in significant processing gain. The processing gains resulting from this structure are proportional to the square root of the number of samples used in the filtering algorithm. For example, a unit cell electrical circuit with 256 analog memory cells 612 may yield a processing gain of 16 if all the available analog samples were used in a matched filter algorithm, assuming Gaussian single pulse modulation, and a normal noise distribution. The term “processing gain” is used here to describe the increase in effective signal-to-noise ratio (“SNR”) realized by performing the described operations on the voltage samples. Assuming the pulsed laser light is distributed uniformly over just the field of view of the receive optics 518, the effective range of the ladar also increases as the square root of the transmitted power (or SNR), and an increase in range to 80 meters may result. Single pulse Gaussian modulation may be characteristic of either a solid state laser or a semiconductor laser with a simple driver, and thus may be an attribute of either a long range ladar sensor 104 or a short range ladar sensor 102.

The unit cell electronic circuit of FIG. 6 is well adapted to single pulse modulation, or to more complex modulation scenarios. In a second modulation scheme, a VCSEL array modulated with a series of Barker encoded flat-topped or Gaussian pulses can be sampled by the unit cell electronics of FIG. 6 and analyzed by data reduction processor 516 for range and intensity estimates. In a third modulation scheme, a VCSEL array modulated with a pulsed sine wave allows for greater cumulative energy to be reflected from a feature in a scene in the field of view of either a short range ladar sensor 102 or a long range ladar sensor 104 without an increase in peak power. Each peak of a pulsed sine wave will have a separate reflection from an object or feature in the scene in the field of view of the ladar sensor 102, 104 and the unit cell electrical circuit of FIG. 6 allows the ladar sensor 102, 104 receiver to respond to the cumulative energy from many of these reflected pulses using a minimum of circuitry. The waveform in one exemplary embodiment is a number of sine wave cycles, and the number could be quite large, depending on a number of factors. The receiver circuitry of the unit cell electronics shown in FIG. 6 is capable of sampling or of synchronously detecting the cumulative energy of the returned pulse peaks. Two sampling modes may be supported by the unit cell sampling structure shown in FIG. 6. When taking analog samples of single pulse or multi pulse sequences, wherein analog samples of an incoming waveform are being sequentially taken, a sampling impedance control 621 (Z) to the circular selector 622 would be set to a minimum value. The sampling frequency of sample clock 618 would also be selected to produce 10-20 analog samples during each pulse width. When the sampling impedance control 621 is set to a minimum, the sample controls S1, S2, S3 turn on with full voltage during a sampling cycle. Since each sampling gate 610 is a field effect transistor (“FET”), increasing the sample control voltage S1-S3 will increase the gate-source voltage on the sampling FET, thus lowering the impedance of the channel between source and drain, and setting the sampling gate impedance to a minimum. When the sampling gate 610 impedance is set to a minimum, the storage capacitor serving as analog memory cell 612 charges rapidly to the voltage present at the output of input amplifier 608. This mode can be termed “instantaneous voltage sampling” to distinguish the mode from a second sampling mode, which is selected when the sampling impedance control 621 is set to a higher, or even maximum value. When the sampling impedance control 621 is selected for high impedance, or maximum series resistance value, the outputs S1-S3 would be at or near minimum voltages when enabled, resulting in a lower gate-source voltage across each of the sampling gate FETs 610, and thus a higher sampling gate series resistance in the channel between source and drain of each sampling gate 610 FET. With the series resistance of the sampling gates 610 set to high or maximum value, the effect is to cause an R-C filter to develop, with the analog memory cell 612 storage capacitor performing as an integrating capacitor. This second sampling mode may be very useful when a sinusoidal modulation is applied to the pulsed laser transmitter 504 in the case where the laser is a semiconductor laser, typically a high efficiency VCSEL. By applying a sampling clock to the sampling gate 610 driven by S1, and which is the same frequency as the sinusoidal modulation, a sum frequency and a difference frequency will be in the sampled signal, and the analog memory cell 612 storage capacitor will filter out the sum frequency, and the difference frequency will be zero, leaving only a DC voltage component, which will be a trigonometric function of the phase difference. Over a number of cycles of the sinusoidal modulation from the output of input amplifier 606, this DC voltage will emerge as the sine or cosine of the phase difference between the transmitted and received waveforms. This phase difference is proportional to the range to a reflecting surface. To improve the processing gain, the second sampling gate driven by the S2 signal is driven by the same sampling clock frequency, but shifted by 90 degrees in phase, and the greater of the two DC voltages, or a ratio of the two voltages, may be used to estimate phase, and thereby range. Typically, a ratio is preferred, as it removes the variation in amplitude of the incoming sine wave as an error term. This type of detection relies on “In-phase” and “Quadrature-phase” local references, and is often referred to as an “I&Q” detection scheme. Thus, the sampling gates 610 can be operated as instantaneous voltage samplers in a first sampling mode, or as frequency mixers in a second sampling mode, depending on the state of the sampling impedance control 621, and the frequency applied by sampling clock 618. In the first sampling mode, the shape of a pulse or sequence of pulses may be acquired, and in second sampling mode, a periodic waveform modulation such as a sine wave, may be demodulated through the frequency mixing effect and integration on a storage capacitor, resulting in a phase measurement and thereby range. Demodulation within the unit cell electrical circuit reduces the data at an early point, reducing the requirements for memory and fast digital processors. Alternatively, the demodulation of a sine wave or other periodic waveform may be performed in data reduction processor 516 on the digitized representations of the analog samples, given a fast arithmetic unit, and the proper algorithm. This illustrates the power and flexibility of the instantaneous voltage sampling mode, as the data reduction processor 516 can be adapted to run PWD, CSC, FIR filter, IIR filter, I&Q, or any number of curve fitting algorithms to increase SNR, measure phase, or otherwise reduce range measurement errors.

FIG. 7A shows a central section view of the detector array 500 according to one exemplary embodiment having a two dimensional array of discrete detector elements 602. A 3×1 linear array 500 of detector elements 602 is shown for clarity, though other larger and smaller linear arrays 500 may be produced. The technology shown here is extendable to any M×N or N×M arrays using many of these same features.

Each discrete detector element 602 is a lateral structure formed by diffusion of n-type 700 and p-type 702 dopants on the illuminated side of an undoped (intrinsic) silicon wafer 704. A black silicon region 706 is the photon absorbing region, created using one of several methods. One method of creating the black silicon is the so called Bosch process which involves switching the parameters of the reactive ion etching (“RIE”) between etching and passivation. Cryogenic RIE in a low pressure oxygen environment also is a method known to produce the fine needle shapes which result in the low-reflectance surface, or “black” silicon. In the Mazur method, short (femtosecond) laser pulses irradiate the surface of the silicon in a partial atmosphere of sulfur hexafluoride and other dopants. Utilizing the Mazur method to create the black surface shifts the apparent bandgap of the silicon absorbing region to nearly 1100 nm. This allows for use of silicon detectors in the near-IR region at 1064 nm where a high power laser source based on a Nd:YAG crystal is well established. Over the top of the n++ ohmic contact diffusion 700, a thin film of titanium is deposited for adhesion, followed by a nickel barrier, forming the cathode (n) contact 708. In this design, all the cathode contacts 708 are reverse biased through a resistor (not shown) at a voltage between 5-20 VDC. The cathode contact 708 and anode contact 710 each have a black nickel film 712, 714 applied in order to reduce optical reflections, which can cause optical crosstalk between pixels in the array 500. Black nickel can be deposited in a wet process which has a well-documented National Aeronautics and Space Administration (“NASA”) specification, documented in a report from Honeywell, Inc. under NASA contract NAS8-31545, completed in June of 1976. Proprietary methods of producing black nickel are also available for deposition using physical vapor deposition (“PVD”) and sputtering processes.

Mesas are formed by etching an isolation trench 716 in the “streets” between detector elements 602. Each anode (p-contact) 710 of detector array 500 is connected to a pixel amplifier circuit 718 by a through-substrate via 720. The pixel amplifier circuits 718 are formed at the same time as the n++ and p++ diffusions are carried out on the reverse side of the wafer 704. Each pixel amplifier circuit 718 has transistors (not shown) formed in n and p diffusion regions (not shown) which are then connected in lower temperature metallization and passivation (silicon oxide formation) steps. In one exemplary embodiment, once the pixel amplifier circuits are completed, the wafer 704 is flipped and the final low temperature processing is performed on the illumination side. These processes include metallization, passivation, black silicon formation, and black nickel coating. The pixel amplifier circuit outputs connect to a metal pad 722 which has a soft metallic bump 724 of indium or solder deposited thereon for interconnect to the ROIC 501 (not shown in FIG. 7A). Amplifier isolation diffusions 726 are carried out simultaneously with the amplifier and detector diffusions.

FIG. 7B shows the bottom side of the detector array 500 of FIG. 7A. A metal pad 728 connects from the though substrate via 720 to the input of pixel amplifier 718. The output of pixel amplifier 718 is a metal pad 722. Deposited atop metal pad 722 is a soft metallic bump 724 of solder or indium. The amplifier isolation diffusions 726 are shown by the dashed lines surrounding each pixel amplifier circuit 718.

FIG. 7C shows a top view of the illumination side of the detector array 500 of FIG. 7A. Detector array 500 may be an M×N rectangular array where N and M may be anywhere from 2 to several hundred pixels on each axis. The black silicon photon absorbing region 706 is shown between the interdigital contacts of each detector element 602 of the detector array 500. The ohmic cathode (n) contacts 708 of each detector element 602 are shown in the center cross sectional view, with the black nickel coating 712 deposited on the top surface to reduce optical reflections. A ground bus 730 is distributed throughout the detector array 500 to provide a connection for a distributed capacitance 732 formed between the cathode contacts 708 and the ground bus 730. A voltage distribution bus 734 is also run in the streets between each row of detector elements 602 of the detector array 500, and a resistive film 736 is deposited between the voltage distribution bus 734 and the cathode contacts 708 of each detector element 602. At the far right of FIG. 7C, a cross sectional view of the cathode connections of each detector element is shown, with the ground bus 730, a silicon nitride insulating film 738, and the cathode contact 708 layered vertically to provide the distributed capacitance 732 to each detector element 602. The ground bus 730, black silicon 706, and resistive film 736 are shown in FIG. 7C in shades of grey or coarse black pattern for clarity. In the actual implementation, however, these surfaces will appear black. The resistive film 734 is typically tantalum nitride, deposited in a PVD process, usually appearing quite black. The black silicon regions 706 are also visually quite black, and the ground bus 730 will typically have a black nickel film deposited thereon as well, to reduce optical reflections.

FIG. 7D shows schematically the arrangement of the cathode contacts 708, distributed capacitance 732, ground bus 730, and resistive film 736. It can be seen the cathode contacts are fed a bias voltage through a resistor 736 formed by deposition of the resistive film, and the cathode contact 708 is decoupled by a local capacitor 732 formed by the overlay of the cathode contact 708 on the silicon nitride dielectric film 738 and the ground plane 730. This arrangement provides a low pass R-C filter which serves to isolate the individual detector elements 602 from transients and noise imposed on the voltage distribution grid 734.

FIG. 8 shows a variant of the detector array 500 which does not have an amplifier. In this embodiment, the anode (p) contact 710 may be connected to the input of the ROIC (not shown in FIG. 8) through the metallic bump 724, the metal pad 728, and the through-substrate via 720. The other elements of this design are unchanged from the design of FIG. 7A.

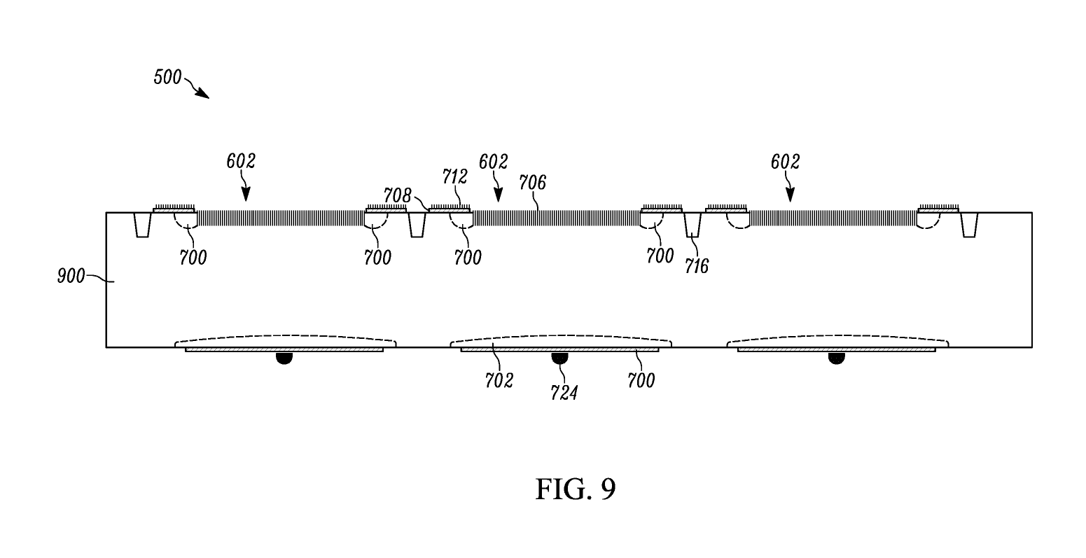

FIG. 9 is another embodiment of the detector array 500 which has a vertical arrangement of anode and cathode for each detector element 602. In this embodiment, each discrete detector element 602 is a vertical structure formed by diffusion of n-type dopants 700 on the illuminated side and p-type dopants 702 on the mating side of an n-doped silicon wafer 900. A black silicon region 706 is the photon absorbing region, created using one of the several methods, as described above. This particular embodiment also uses the Mazur method, but other methods of creating the black silicon region are known and may be used to create similar effects. Over the top of the n++ohmic contact diffusion 700, a thin film of titanium is deposited for adhesion, followed by a nickel barrier, forming the cathode (n) contact 708. In this design, the cathode contacts 708 and n++ diffusions 700 form a ring (not shown) around the black silicon photon absorbing region 706. The cathode contacts 708 are reverse biased at a voltage between 5-20 VDC and may in some embodiments connect to a local capacitor 732 and through a resistor 736 as shown in FIGS. 7C and 7D. The cathode contact 708 has a black nickel film 712 applied in order to reduce optical reflections, reducing any optical crosstalk between pixels in the array 500. Mesas (not separately numbered) are formed by etching the isolation trench 716 in the streets (not numbered) between detector elements 602. Each anode (p-contact) 710 of detector array 500 is connected to a unit cell of the ROIC 501 (not shown on FIG. 9) by the metallic bump 724.

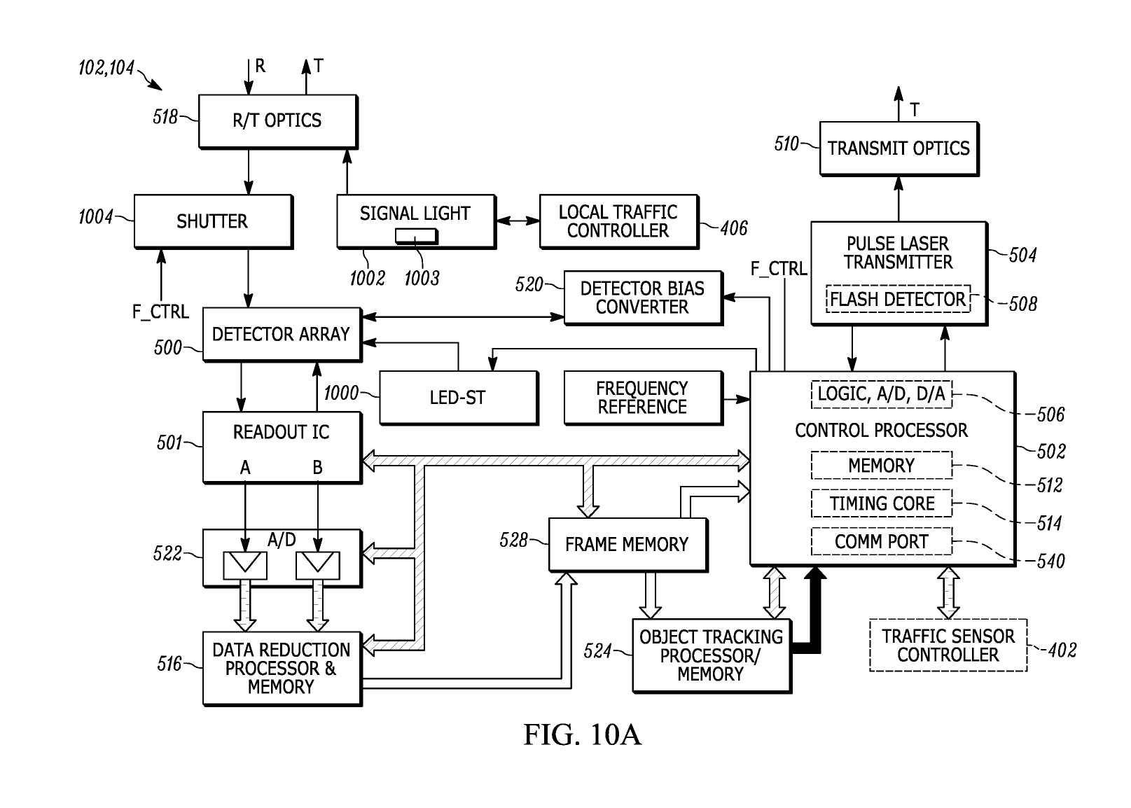

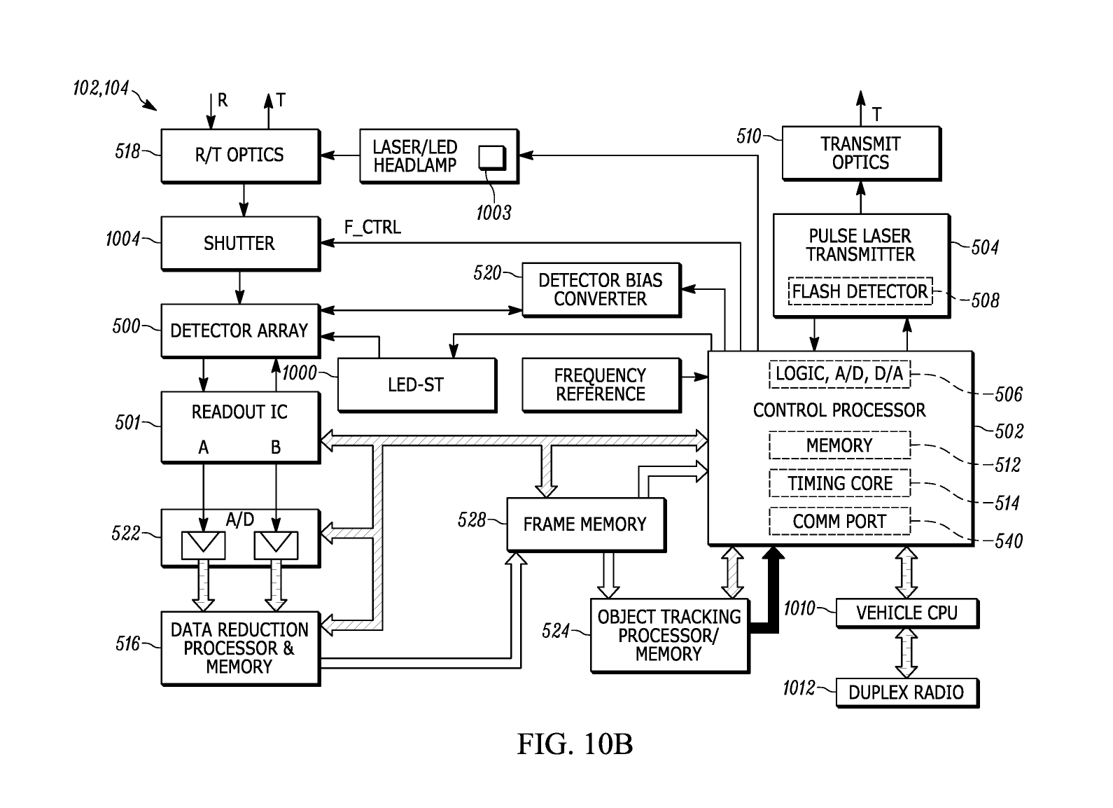

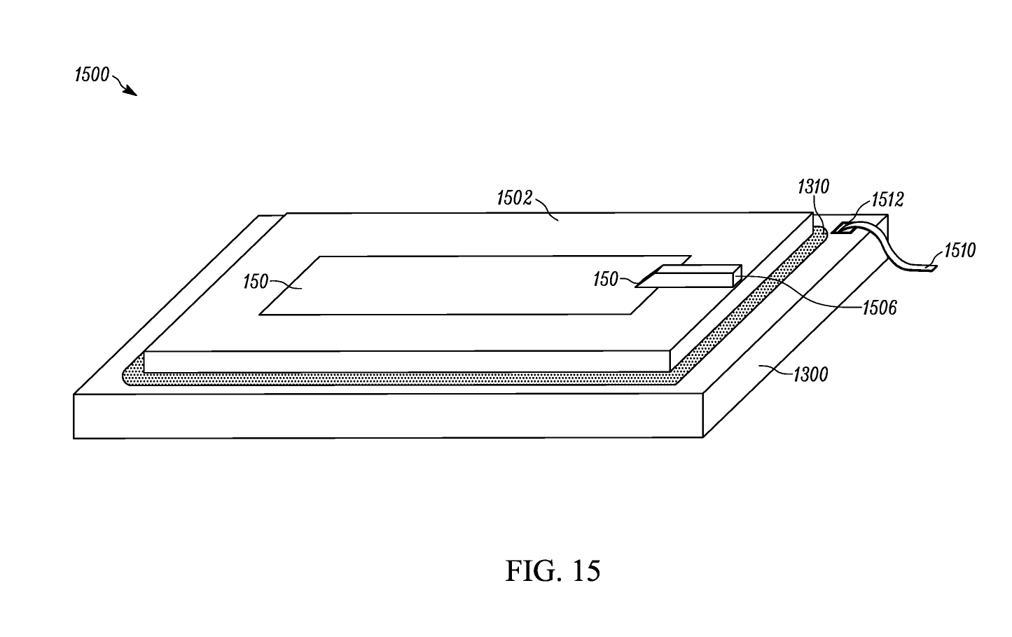

FIG. 10A is a block diagram of an embodiment of the ladar sensors 102, 104 integrated within a lamp housing of the traffic signal, as illustrated in FIG. 2. The diagram is applicable to both long range ladar sensors 104 and short range sensors 102 as described above. FIG. 10A is similar in most respects with FIG. 5, except for the inclusion of an LED self-test circuit 1000, a signal light 1002 implemented with a plurality of colored LEDs 1003, a shutter 1004, and the modified receive optics 518, which in this embodiment provides for a receive and transmit path. The ARC pixel lightguide is eliminated, as the functions can be taken up by the flash detector 508, control processor 502, and LED self-test circuit 1000. The local traffic controller 406 may reside in a housing 1100 (as shown in FIG. 11) with the long range ladar sensor 102 and signal light 1002, or it may be in a pedestal, mounted on a pole, or in another traffic signal 106. In operation, the LED self-test circuit 1000 is stimulated by control processor 502 when the system needs to know if the detector array 500 and ROIC 501 are working. LED light reflected from the inside of the package shown in FIG. 15 is detected in an ARC pixel region 1404 (not shown in FIG. 15) by the detector array 500 and ROIC 501. The control processor 502 may initiate dark current measurements by operating the shutter 1004 by issuing a F_CTRL command to an actuator (not shown) of the shutter 1004 which rotates an aperture flag (not shown) in front of the detector array 500, thereby shutting off all light incoming to the detector array 500. The signal light 1002 may be operated simultaneously with long range ladar sensor 104 shown here by virtue of a dichroic mirror 1100, also referred to as a dichroic optic, which is shown in the cross sectional view in FIG. 11.

FIG. 10B is a block diagram of the ladar sensor 102, 104 integrated within the headlight assembly 109 of the vehicle 108, as illustrated in FIG. 1. The diagram is applicable to both long range ladar sensors 104 and short range sensors 102 described above. The embodiment of FIG. 10B is similar in most respects with the embodiment of FIG. 10A, except for the elimination of the signal light 1002, and the replacement of the colored LEDs 1003 in FIG. 11 with a headlamp 1006 having a plurality of white LEDs 1003. Alternatively, laser lights 1003 may be used for higher efficiency, which use a blue or UV semiconductor laser to stimulate a white phosphor in an array of compact packages. The traffic sensor controller 402 is also eliminated, and a vehicle CPU 1010 supervises the operation of long ladar sensor 104 and connects to the local traffic controller 406 (not shown on FIG. 10B) through a duplex radio link 1012. The operations of vehicle mounted long range ladar sensor 104 and headlight assembly 109 are otherwise the same as described with respect to the drawing of FIG. 10A, except the vehicle CPU 1010 operates in a slave mode when the presence of a local traffic controller 406 is indicated, typically by communication through duplex radio link 1012. In another embodiment, a short range ladar sensor 102 is embedded in an auxiliary signal light (not shown), and the LEDs 1003 may be yellow for a turn signal, or red for brake light or tail light assemblies.

FIG. 11 is a cutaway view of the integrated traffic signal and ladar sensor 102, 104 of FIGS. 2 and 10A, but which also applies to FIGS. 1 and 10B. A housing 1102 includes a lens 1104 which also functions as an environmental seal to keep wind, water, and dust from interfering with the operations of a ladar receiver 1105 and the signal light 1002. The signal light 1002 includes the plurality of LEDs 1003 mounted to a circuit board 1106, which is retained in a recess 1108 in housing 1102 by thread forming screws or other suitable fasteners. The LEDs 1003 are switched on by a signal from local traffic controller 406. Light from the LEDs 1003 is reflected by the dichroic mirror 1100, and radiated through lens 1104 to signal to vehicle and pedestrian traffic within a prescribed field of view. In one embodiment, where the traffic signal is a yellow (or amber) light, the dichroic mirror 1100 reflects yellow light in the range of 570-615 nm, and passes light in the range of 1064 nm substantially unattenuated. The laser transmitter 504 associated with the long range ladar sensor 104 is mounted to housing 1102 by means of thread forming screws or other fasteners, and the transmit optics 510 condition the output beam to cover the desired field of view. Typically, transmit optics 510 is a diffusing lens designed to provide a rectangular or elliptical field of illumination for ladar receiver 1105 which is also mounted to housing 1102 by thread forming screws or other suitable fasteners. Ladar receiver 1105 is comprised of all the elements of FIG. 10A minus the laser transmitter 504, transmit optics 510, shutter 1004, R/T optics 518, signal light 1002, local traffic controller 406, and traffic sensor controller 402. Two lens elements 1108 and 1110 are shown which focus incoming infrared light, and correct for any distortions created by lens 1104 and dichroic mirror 1100. Lens elements 1108 and 1110 may be logically considered as a part of ladar receiver 1105.

An aperture flag 1112 is a black metallic plate mounted to a cylindrical shaft 1114, and sized to block any light incident on ladar receiver 1105. Aperture flag 1112 is normally positioned in a recess 1116 in the housing 1102. When a dark current calibration of the ladar receiver 1105 is desired, a command (F_CTRL) from control processor 502 initiates the shutter 1004 by causing a rotary actuator 1118 to swing aperture flag 1112 into the space between lens elements 1108 and 1110, blocking any light from reaching the ladar receiver 1105. One embodiment of the long range ladar sensor 104 calls for operation with infrared light at 1064 nm, but any wavelength of light which does not cause interference with the traffic signals may be utilized, though typically the desired wavelengths are in the infrared. The use of a long range ladar sensor 104 with the yellow signal light 1002 may be implemented, alternatively, with any color of signal light, turn arrow, or crosswalk signal and/or with the short range ladar sensor 102.

FIG. 12 shows the mating of detector array 500 with ROIC 501. The drawing shows an 11×7 array of detector elements 602 for clarity; normally the detector arrays have a minimum of 32 rows or columns. The metallic bumps 724 (not visible in this view) on detector array 500 are mated with metallic bumps 1200 which are deposited atop each mating unit cell of ROIC 501. The metallic bumps 1200 may comprise indium, however, other metals and/or compounds may be used instead. The metallic bumps 1200 and 724 connect each anode 710 contact of the detector array 500 to an input amplifier 606 of the unit cell electrical circuit shown in FIG. 6. In the case of metallic bumps 1200, the detector array 500 and the ROIC 501 are optically aligned in a flip-chip bonder and heavily pressed together to create a cold flow weldment between metallic bump 724 and metallic bump 1200. In the case where the bumps 724 and 1200 are solder bumps, the chips are aligned in a flip-chip bonder and pressed together lightly to create contact and some deformation, and the solder is then reflowed to create a permanent bond.

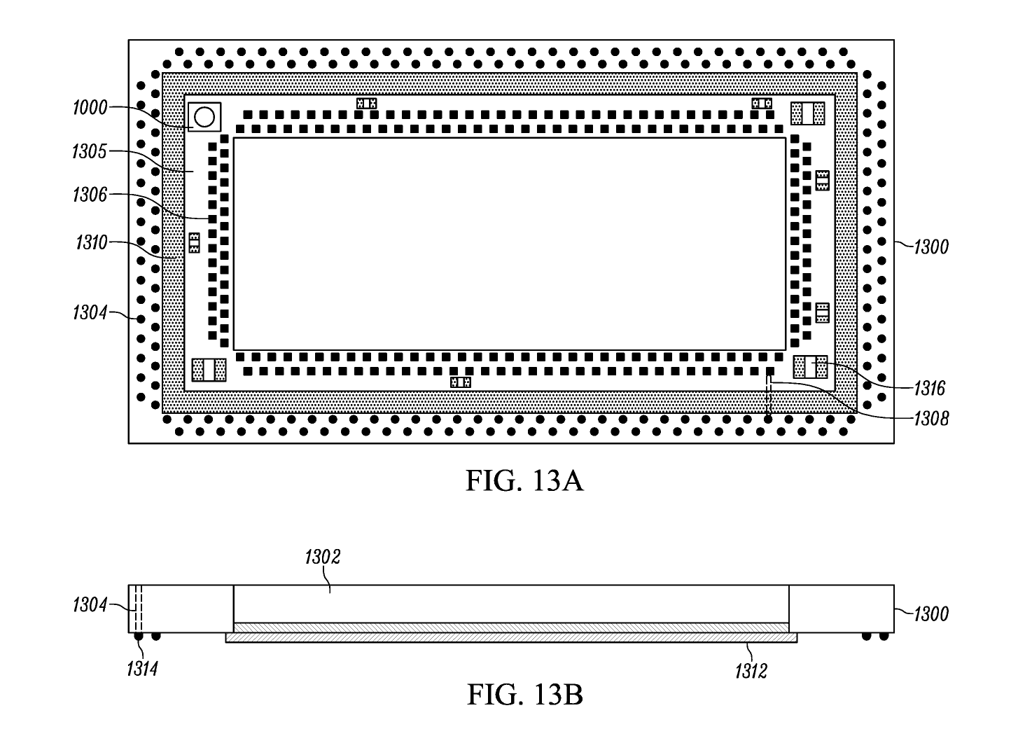

FIG. 13A shows a top view of a circuit substrate 1300. Circuit substrate 1300 is typically a ceramic, e.g., alumina, aluminum nitride, or beryllium oxide, depending on the application. FIG. 13B is a section view showing a recess 1302 formed by laser cutting of a flat ceramic plate 1303, or by die cutting of an unfired (green) ceramic plate, the plate then being fired and lapped flat. Conductors are then formed by an additive thick film process, where conductive inks are applied through a silk screen mask or stencil and then fired at an elevated temperature. A number of laser drilled through substrate vias 1304 are filled at the same time a first conductive layer is printed on the plate 1303, which has bond pads 1306 and buried traces 1308 which connect to a periphery and the vias 1304. This first conductive layer is then fired and an insulating layer of alumina/glass is then printed and fired to allow for a multi-layer circuit to be formed on the top (circuit) surface of circuit substrate 1300. Next, a conductive picture frame pattern 1310 is printed and fired in a second conductive layer, typically a solderable palladium/silver film. A plated Covar® insert 1312 is then brazed into the recess 1302, providing a hermetic barrier. The insert 1312 may be machined or stamped and coined in a progressive die. The insert 1312 is plated with a copper strike followed by a nickel plating, and finally a thin gold film. The bottom side of circuit substrate 1300 has an array of two rows of metallic balls 1314 applied (ball grid array). Also shown are a number of circuit components soldered to the circuit side, including a number of decoupling capacitors 1316 and built in self-test LED 1000.

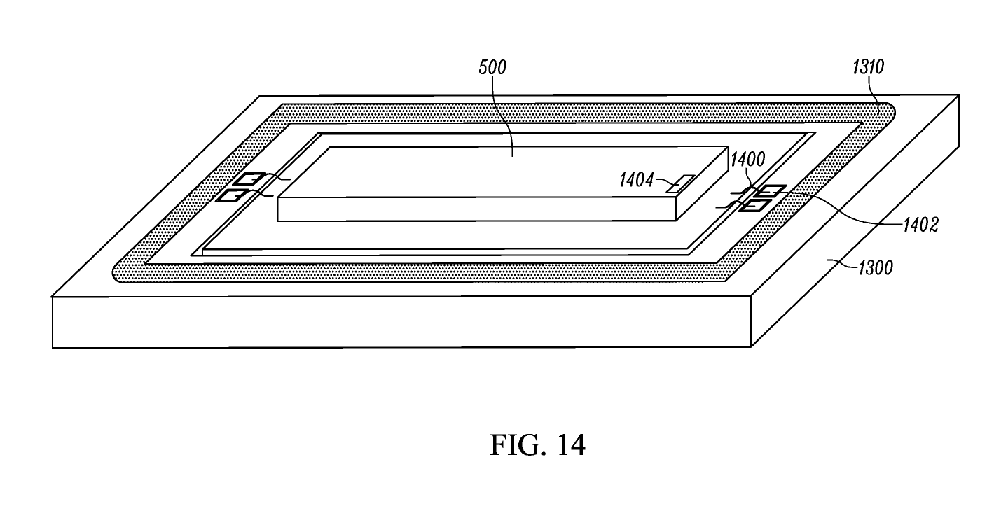

FIG. 14 shows the ROIC 501 with the detector array 500 attached after it has been assembled into the recess in the circuit substrate 1300, and secured therein with solder or an electrically conductive epoxy. Electrical connections are made from the ROIC 501 to circuit substrate 1300 by wire bonds 1400 which terminate on bondable gold pads 1402. An ARC pixel region 1404 is identified on detector array 500 where light sampled from the transmitted laser pulse will be directed. The conductive picture frame pattern 1310 is configured to receive a window cover (not shown) to seal the assembly and provide some optical filtering.

FIG. 15 shows the final assembly of a hermetic package 1500 containing the detector array 500, ROIC 501, capacitors 1316, and self-test LED 1000. A hermetic window cover 1501 comprised of flat window glass (not separately numbered) is retained in a CoVar® frame 1502, and attached by a continuous solder seam or brazing weldment to the thick film picture frame conductor 1310. A lightguide 1506 is optionally provided by epoxy or thermal staking to window cover frame 1502. The lightguide 1506 has an input face 1507 adapted to receive an optical sample of the transmitted laser pulse (ARC), and an angled output coupling surface 1508 which is aligned to illuminate the ARC pixel region 1404 (not shown in FIG. 15). A single beam lead 1510 of a leadframe is shown attached to peripheral pad 1512, a low cost alternative to the ball grid array of FIG. 13. The window cover 1501 may also have a filter applied to a surface in the form of a thin optical film which rejects all light but the wavelength of interest; typically 1050-1075 nm in the present design. The window cover 1501 is attached to the frame 1502 by a frit seal process, where a low temperature glass alloy is applied in a frit powder form and the assembly then heated until the glass frit powder reflows, permanently attaching the window cover 1501 to frame 1502. In this manner, a low cost, yet hermetic and high performance package for the FPA assembly may be effected. The innovative hermetic package 1500 has improved electrical performance due to reductions in parasitic inductance.

In the exemplary embodiments described herein, a number of digital processors have been identified, some associated with the traffic zone, some associated with the ladar sensor, and some associated with the traffic district. It should be appreciated that other partitioning and naming conventions may be used without changing the scope or intent, or affecting the utility of the disclosure. The function of those processors associated with the traffic sensors 402 and ladar sensors 102, 104 may be combined in a single digital processor in some future embodiments. Local traffic controller 406 and district control processor 410 may in some embodiments be combined. Likewise, the object tracking processor 524 of the individual ladar sensor may be absorbed into the traffic sensor controller 402, as could other ladar sensor processors such as the data reduction processor 516. This would follow a trend toward greater centralization of the computing power. A trend towards decentralization may also take place in reverse, some alternative embodiments having ever more of the processing power pushed down into the ladar sensor. The term digital processor may be used generically to describe either digital controllers or digital computers, as many controllers may also perform pure mathematical computations, or perform data reduction, and since many digital computers may also perform control operations. Whether a digital processor is termed a controller or a computer is a descriptive distinction, and not meant to limit the application or function of either device.

Having now described various exemplary embodiments of the disclosure in detail, those skilled in the art will recognize modifications and substitutions to the specific embodiments disclosed herein. Such modifications are within the scope and intent of the present disclosure as defined in the following claims.

1. A ladar enabled traffic control system, comprising:
at least one traffic signal configured to control traffic at an intersection;
at least one ladar sensor mounted and sighted to have a field of view at or adjacent to the intersection;
a controller in communication with the traffic signal and the at least one ladar sensor and adapted to control the condition of the traffic signal light based at least partially on data provided by the at least one ladar sensor.

2. The traffic control system of claim 1, wherein the ladar sensor includes:
a laser transmitter with a pulsed laser light output and a diffusing optic adapted to illuminate a reflecting surface in the field of view;
receiving optics adapted to collect and condition the pulsed laser light reflected from the reflecting surface;
a two dimensional array of light sensitive detectors positioned at a focal plane of said receiving optics, and each of said light sensitive detectors intercepting a pixelated portion of the pulsed laser light output reflected from the reflecting surface, and each light sensitive detector having an output producing an electrical response signal; and
a readout integrated circuit with a clock circuit and a plurality of unit cell electrical circuits.

3. The traffic control system of claim 2, wherein the ladar sensor further includes:
a time zero reference circuit positioned to intercept a portion of said pulsed laser light output, and having a time zero reference output adapted to signal the beginning of the pulsed laser light output; and
a detector bias circuit connected to a voltage distribution grid of said array of light sensitive detectors;
and each of said unit cell electrical circuits having an input connected to the clock circuit and to the time zero reference electrical output, and having an amplifier with an input connected to one of the light sensitive detector outputs, and each amplifier having an output, and a pulse detection circuit connected to said amplifier output, and the pulse detection circuit having a termination output, a counter connected to the time zero reference electrical output and to said clock circuit, said counter started counting by the time zero reference electrical output, and said counter connected to, and stopped counting by the termination output, and the counter having an output proportional to the distance to the reflecting surface.

4. The traffic control system of claim 1 wherein the ladar sensor is mounted to a traffic signal light.

5. The traffic control system of claim 1 wherein the ladar sensor is mounted to a vertical section of a pole.

6. The traffic control system of claim 1 wherein the traffic controller is connected to a radio link.

7. The traffic control system of claim 1 wherein the traffic signal light is suspended from a cable.

8. The traffic control system of claim 1 wherein the local traffic controller (no antecedent basis, as you removed the word local in claim 1) is in communication with a district traffic controller.

9. The traffic control system of claim 1 wherein a local traffic controller is in communication with at least one visible light camera.

10. An integrated traffic signal and ladar sensor comprising:
a housing;
a traffic signal;
a dichroic optic;
and a ladar sensor having a field of view, and said ladar sensor having;
a laser transmitter with a pulsed laser light output and a diffusing optic adapted to illuminate a reflecting surface in the field of view,
a time zero reference circuit positioned to intercept a portion of said pulsed laser light output, and having a time zero reference output adapted to signal the beginning of the pulsed laser light output,
receiving optics adapted to collect and condition the pulsed laser light reflected from the reflecting surface,
a two dimensional array of light sensitive detectors positioned at a focal plane of said receiving optics, and each of said light sensitive detectors intercepting a pixelated portion of said pulsed laser light output reflected from the reflecting surface, and each light sensitive detector having an output producing an electrical response signal,
a detector bias circuit connected to a voltage distribution grid of the array of light sensitive detectors,
a readout integrated circuit with a clock circuit and a plurality of unit cell electrical circuits,
and each of said unit cell electrical circuits having an input connected to the clock circuit and to the time zero reference electrical output, and having an amplifier with an input connected to one of the light sensitive detector outputs, and each amplifier having an output, and a pulse detection circuit connected to the amplifier output, and the pulse detection circuit having a termination output, a counter connected to the time zero reference electrical output and to said clock circuit, and the counter started counting by the time zero reference electrical output, and the counter connected to, and stopped counting by the termination output, and the counter having an output proportional to the distance to the reflecting surface.

11. The traffic signal and ladar sensor of claim 10 wherein the traffic signal light is selected from the set of a red light, a green light, a yellow light, a turn arrow, and a crosswalk signal.

12. The traffic signal and ladar sensor of claim 10 wherein said traffic signal is a signal light produced by a plurality of LEDs.

13. The traffic signal and ladar sensor of claim 10 wherein said receiving optics have an electromechanical shutter mounted in a light receiving path.

14. The traffic signal and ladar sensor of claim 10 wherein said traffic signal and ladar sensor are mounted within a common housing.

15. The traffic signal and ladar sensor of claim 10 wherein said traffic signal and ladar sensor are mounted to a vertical section of a pole.

16. The traffic signal and ladar sensor of claim 10 wherein said traffic signal and ladar sensor are mounted to a horizontal section of a pole.

15. A vehicle having a ladar sensor and lamp assembly comprising:
a housing mounted to the vehicle, and the housing having a lamp assembly and a ladar sensor mounted therein, and the lamp assembly and ladar sensor having overlapping fields of view, and the housing further having a dichroic optic;
and the vehicle having a central processing unit connected to said ladar sensor,
and the central processing unit connected to a duplex radio link,
and the ladar sensor having a field of view and having;
a laser transmitter with a pulsed laser light output and a diffusing optic adapted to illuminate a reflecting surface in said field of view,
a time zero reference circuit positioned to intercept a portion of said pulsed laser light output, and having a time zero reference output adapted to signal the beginning of the pulsed laser light output,
receiving optics adapted to collect and condition the pulsed laser light reflected from said reflecting surface,
a two dimensional array of light sensitive detectors positioned at a focal plane of the receiving optics, and each of the light sensitive detectors intercepting a pixelated portion of the pulsed laser light output reflected from the reflecting surface, and each light sensitive detector having an output producing an electrical response signal,
a detector bias circuit connected to a voltage distribution grid of the array of light sensitive detectors,
a readout integrated circuit with a clock circuit and a plurality of unit cell electrical circuits, and
each of the unit cell electrical circuits having an input connected to said clock circuit and to the time zero reference electrical output, and having an amplifier with an input connected to one of the light sensitive detector outputs, and each amplifier having an output, and a pulse detection circuit connected to the amplifier output, and the pulse detection circuit having a termination output, and a counter connected to the time zero reference electrical output and to the clock circuit, the counter started counting by the time zero reference electrical output, and the counter connected to, and stopped counting by the termination output, and the counter having an output proportional to the distance to the reflecting surface.

16. The vehicle of claim 15 wherein said array of light sensitive detectors has detector elements with a photon absorbing region of black silicon and an electrode orientation selected from the set of; lateral and vertical.

17. The vehicle of claim 15 wherein said laser transmitter is an array of semiconductor lasers.

18. The vehicle of claim 15 wherein said lamp assembly is selected from the set of; a headlight, a brake light, a tail light, and a turn signal.

19. The vehicle of claim 15 further comprising a duplex radio link.

20. The vehicle of claim 15 wherein said lamp assembly is an array of diodes selected from the set of; LEDs and laser diodes.
